(19) United States
(12) Patent Application Publication
(10) Pub. No.: US 2026/0064974 A1
(43) Pub. Date: Mar. 5, 2026

(54) USING GENERATIVE AI TO INTEGRATE MULTI-DIMENSIONAL DATA WITH DATA CONSUMERS USING NATURAL LANGUAGE

(71) Applicant: Oracle International Corporation, Redwood Shores, CA (US)

(72) Inventors: Gopalakrishnan Venkatesh, Karnataka (IN); Kenneth Lau, Santa Clara, CA (US); Shifu Jain, Harding Township, NJ (US); Toufic Wakim, Danbury, CT (US); Prakash Khubchandani, Danbury, CT (US); Shaji Puthanveettil, Santa Clara, CA (US); Soomin Lee, Zurich (CH)

(73) Assignee: Oracle International Corporation, Redwood Shores, CA (US)

(21) Appl. No.: 19/169,293

(22) Filed: Apr. 3, 2025

Related U.S. Application Data
(60) Provisional application No. 63/687,854, filed on Aug. 28, 2024.

(51) Int. Cl. G06F 40/35; G06F 3/04845; G06F 3/04847

(52) U.S. Cl. CPC G06F 40/35; G06F 3/04845; G06F 3/04847

(57) ABSTRACT

Systems, methods, and computer-readable media are provided for triggering functionality on data to be generated in a user interface and/or data shown or visualized in a user interface based on a natural language request that references actions to be performed and data items to use in performing the actions. The user interface actions are triggered based on a structured object generated by a large language model (LLM), which may then be processed, validated, and used to carry out the actions. The LLM may be further instructed based on available interface functionality control(s) and which content has been selected on the user interface. The structured object may be used to generate output content that is based on the selected content, such as a summary or other text transformation, a targeted visualization, output document for consumption by another application, or other consumable content. The output content may be stored in association with a content consumer for display in a user interface.

### CROSS-REFERENCE TO RELATED APPLICATION(S)

This application claims the benefit of U.S. Provisional Patent Application No. 63/687,854, filed on Aug. 28, 2024, the entire disclosure of which is incorporated by reference herein in its entirety for all purposes.

### BACKGROUND

Data is shown in data visualization tools, such as Microsoft Excel®, and a user may interact with data by clicking on the data and modifying the data. A variety of data storage, manipulation, and visualization tools exist to manage data for a variety of purposes. For example, data may be stored in cells, such as rows and columns, where the data may be organized for data manipulation tasks. As another example, data may be stored in records, portions of which may be shown via a user interface in support of a variety of types of application functionality.

As data is visualized in applications and other tools, the data may be modified by updating a field displayed in an interface, a cell displayed in a spreadsheet, or by filling out a form. An application or an instance of an application may store the updated data in a database so that same or different instances of the application or other applications may retrieve the updated data to use for similar or different purposes. In this manner, cloud applications may work together and separately to make use of shared or private datasets and achieve more functionality than offered by any individual cloud application.

### BRIEF SUMMARY

In some embodiments, a computer-implemented method includes triggering functionality on data to be generated in a user interface and/or data shown or visualized in a user interface based on a natural language request that references actions to be performed and data items to use in performing the actions. The user interface actions are triggered based on a structured object generated by a large language model (LLM), which may then be processed, validated, and passed into the application to trigger the actions.

In one embodiment, a computer-implemented method includes accessing a natural language request received in a user session with an application. Content is graphically selected in the user session when the natural language request is received. The computer-implemented method further includes generating a prompt that includes the natural language request, information indicating the selected content, and one or more interface functionality controls for controlling interface functionality to generate output content. The computer-implemented method further includes prompting a large language model with the prompt. The computer-implemented method further includes receiving a result of the prompt, the result comprising an interface functionality specification that uses at least one of the one or more interface functionality controls and is based at least in part on the information indicating the selected content. The computer-implemented method further includes causing execution of the at least one of the one or more interface functionality controls to generate particular output content that is based at least in part on the information indicating the selected content. The computer-implemented method further includes storing the particular output content in association with a content consumer for display in a user interface.

In a further embodiment, the particular output content comprises a textual transformation of the graphically selected content. The at least one of the one or more interface functionality controls causes display of the textual transformation on the user interface. The graphically selected content comprises textual content displayed in a first region of the user interface. The information indicating the selected content comprises at least part of the selected content. The at least one of the one or more interface functionality controls causes display of the textual transformation in a second region of the user interface concurrently with the textual content.

In the same or a different further embodiment, the particular output content comprises a textual transformation of the graphically selected content. The at least one of the one or more interface functionality controls causes display of the textual transformation on the user interface. The graphically selected content comprises a visualization displayed on the user interface. The information indicating the selected content comprises a data schema corresponding to one or more data slices shown in the visualization. The at least one of the one or more interface functionality controls causes display of the textual transformation concurrently with the visualization.

In the same or a different further embodiment, the particular output content comprises a textual transformation of the graphically selected content. The at least one of the one or more interface functionality controls causes display of the textual transformation on the user interface. The graphically selected content is displayed on the user interface before storing the particular output content in association with a content consumer separately from the graphically selected content. The at least one of the one or more interface functionality controls causes display of the textual transformation instead of the graphically selected content on the user interface after storing the particular output content in association with the content consumer.

In the same or a different further embodiment, the computer-implemented method further includes causing display of a plurality of reduced-scale images corresponding to different candidate visualization types that are stored in association with different interface functionality controls. The computer-implemented method further includes receiving a selection of a particular selectable reduced-scale image of the plurality of reduced-scale images, the selection indicating a candidate visualization type. The computer-implemented method further includes, based at least in part on the selection, selecting for inclusion in the prompt, the one or more interface functionality controls stored in association with the candidate visualization type. In a further embodiment, the plurality of reduced-scale images corresponding to the different candidate visualization types are determined after filtering a superset of candidate visualization types to exclude one or more other candidate visualization types and include the different candidate visualization types based on relevance to the graphically selected content. In the same or a different further embodiment, the plurality of reduced-scale images corresponding to the different candidate visualization types are displayed in a chat region of the user interface where the natural language request is received.

In the same or a different further embodiment, the generating the prompt, the prompting the large language model, the receiving the result, the causing execution of the at least one of the one or more interface functionality controls, and the storing the particular output content are performed as separate process instances for each of a plurality of different interface functionality controls that control a plurality of different candidate visualization types. Completion of the separate process instances of the storing the particular output content causes the particular output content for each of the separate process instances to be displayed as a selectable reduced-scale image of a plurality of selectable reduced-scale images. The computer-implemented method further includes receiving a selection of a particular selectable reduced-scale image of the plurality of reduced-scale images, and, based at least in part on the selection, causing a particular non-reduced scale image corresponding to the reduced scale image to be added to the user interface and displayed.

In the same or a different further embodiment, the content is graphically selected in the user session using a first user interface of the application. The content consumer is a different application. The computer-implemented method further includes instantiating the different application with the particular output content to cause the display in the user interface. The user interface is a second user interface of the different application.

In the same or a different further embodiment, the particular output content comprises a textual transformation of the graphically selected content. The computer-implemented method further includes causing display of the particular output content in a chat region of the user interface where the natural language request is received. The computer-implemented method further includes receiving a selection, from the chat region, to include the particular output content in another region of the user interface as part of a target object. The at least one of the one or more interface functionality controls causes, in response to the selection, display of the textual transformation in the other region of the user interface as part of the target object.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example process that triggers functionality on data to be generated in a user interface and/or data shown or visualized in a user interface based on a natural language request that references actions to be performed and data items to use in performing the actions.

FIG. 1B illustrates a flow chart of an example process 100B that causes generation of a view of slice(s) of data across different dimensions with filter(s) applied to include some dimension(s) and exclude other dimension(s).

FIG. 1C illustrates a flow chart of an example process 100C that causes updating a displayed representation using control(s) of the displayed representation.

FIG. 1D illustrates a flow chart of an example process 100D that generates output content that is derived from selected content and stored for use by a content consumer.

FIG. 2 illustrates a system diagram showing an example cloud infrastructure that triggers functionality on data to be generated in a user interface and/or data shown or visualized in a user interface based on a natural language request that references actions to be performed and data items to use in performing the actions.

FIGS. 3-19 illustrate example user interfaces supporting various embodiments described herein.

FIG. 20 depicts a simplified diagram of an example distributed system for implementing certain aspects.

FIG. 21 is a simplified block diagram of one or more components of an example system environment by which services provided by one or more components of an embodiment system may be offered as cloud services, in accordance with certain aspects.

FIG. 22 illustrates an example computer system that may be used to implement certain aspects.

### DETAILED DESCRIPTION

A description is provided for triggering functionality on data to be generated in a user interface and/or data shown or visualized in a user interface based on a natural language request that references actions to be performed and data items to use in performing the actions.

In various embodiments, an application instance, agent instance, service instance, or other software client may manage a user interface to generate a user interface data view from a structured description. The user interface component to be displayed may be generated from different dimensions of data with different filter(s) and/or roll-up(s) applied based on a natural language request. A large language model (LLM), which may include any natural language processing model or service or a combination of models and/or services, may generate a structured object to use for invoking an API to generate the user interface component. The approach provides the LLM with information about existing dimension data to allow the LLM to match existing dimension data and descriptions with the natural language provided. The LLM may automatically generate multidimensional expression language (MDX) statements based on the request to drive multidimensional functionality for the view. The LLM may also recommend a shape of a grid to use for displaying LLM-selected data from among the data provided to the LLM.

The client may alternatively or additionally intelligently interact with a UI object or visualization structure (such as a structure driving a visualization in an application) to make updates or modifications driven by the LLM, even while the UI object or the visualization is being displayed.

The client may alternatively or additionally trigger UI functionality on a dynamic data item (already shown) using the LLM to generate a structure object corresponding to an action to be triggered, such as zoom in/out, swapping in/out variables, dimensions, changing formatting conditions, etc. The client may additionally or alternatively trigger a visualization on dynamic data item(s) by using the LLM to make a selection of a visualization mode from among specified candidate visualization modes, relevant to the natural language request. The visualization or an update thereto may be triggered corresponding to the selected visualization mode using a structured object. The client may additionally or alternatively modify an existing visualization already shown based on what data is being shown, automatically updating a type of visualization to use for a new shape of data to be displayed.

In various embodiments, the client may intelligently modify how displayed data should be processed for consumption in a downstream process or application. The client may additionally or alternatively highlight text or other content in the UI, and actions may be performed against the highlighted text or other content based on a natural language request such as one provided in a chat session. For example, the highlighted content may be transformed by rephrasing, summarizing, replacing, or reformatting, such as for Microsoft PowerPoint®, Microsoft Excel®, Intuit Quickbooks® or another application for visualizing, managing, presenting, or modifying objects. Content and/or a visualization may be saved to a package for distribution to different applications, and/or added to a report for that package. A preview of any visualizations that are available for a certain package may be shown with actual data as the data would appear in the report.

Various data elements may be selected, manipulated, or processed with the structured assistance of the LLM even though details relevant to the data being manipulated or processed might not be displayed in the user interface. Such details may be gleaned from the visualization or other displayed representation of data using an underlying data schema and a definition of the visualization or displayed representation of data.

Steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Multi-Dimensional Data Management

Hierarchical data may be stored as a cube or a collection of dimensions, where each dimension has members arranged in a hierarchy. A “dimension” is a collection of related data items that are organized together and, for example, may share a common data structure, schema subset, or index, and may be related to other dimensions. Dimensions may have one or more attributes or fields that define values, or that define formulas for obtaining values. Non-limiting examples of dimensions may include account, department, business unit, product line, market, division, time, and location, and each dimension may have multiple levels of members or nodes with information. As used herein, the terms “member,” “node,” and “row” are used interchangeably to refer to an individual item of data hierarchically positioned in a structured dataset. Each member may be a child of another member or a root member for the dimension, forming a tree of members for each dimension that can be represented as a drill-down hierarchy of members along each dimension.

Data may be maintained at the lowest levels of the tree structure and rolled up to higher levels. For example, data on the monthly level of time data of January, February, and March may be rolled up to data on the quarterly level of time data, which may be rolled up to data on the annual level of time data. Similarly, data at the city level of a location dimension may be rolled up to data on the state level of the location dimension, which may be rolled up to data at the country level. Other dimensions, such as product information, sales information, and other information, may be linked to the time dimension such that slices of data may be obtained as intersections between the corresponding values for the corresponding dimensions. Dimensions may be linked together using keys or other references that identify specific members of other dimensions associated with a record. Additional details may be pulled from the other dimensions using the key as a reference to the other dimension and drilling down or rolling up in the data structure along the other dimension. For example, information about a particular product having units sold in a given quarter may be determined from an intersection between the product, sales, and time dimensions as a data slice.

A schema or hierarchical structure may be applied to the members, and different dimensions may support different sub-schemas of the database where data fitting within the dimension conforms to a certain data format and has certain well-defined relationships with other data in the dimension. Data fitting within certain parts of the schema or hierarchical structure may feed into or be bound to formulas, workflows, models or other logic managed by an application to use the data to efficiently determine values or accomplish tasks. For example, the weight of all units in a “units produced” portion of the hierarchy may be used in a first formula for determining individual shipping costs for each unit and a second formula for aggregating shipping costs across all units.

In one embodiment, a multidimensional data management application provides access to data for analysis and management. Dimensions that align with existing structures, relationships, and logic in a stored hierarchy of data may have pre-configured structure, relationships, and logical formulas, models, or workflows that use the values provided or statically defined to populate other dynamic nodes that depend on the static values. Uploaded data may fit into a structure expected by existing logic such that the existing logic is automatically updated as the uploaded data is provided. For example, if a dynamic node exists where all children nodes are summed together, and the uploaded data adds or updates a child node of the dynamic node, the dynamic node may be updated automatically to account for the uploaded data.

In one embodiment, a data management application such as Oracle Essbase® provides views of multidimensional data, and the views provide options for modifying or analyzing the multidimensional data according to a data management user interface. In one example, the views are displayed in a Microsoft Excel interface using a Microsoft Office® add-on such as SmartView® to control what data is visible in which cells, whether that data is modifiable, and what database structures of a back-end database are mapped to the cell such that the corresponding cell holds value(s) of the database structures and the database structures get modified when the corresponding cell gets modified.

In another example, the views are displayed in a browser interface that shows a grid of cells where code executed in the browser controls what data is visible in which cells, whether the data is modifiable, and what database structures of a back-end database are mapped to the cell such that the corresponding cell holds value(s) of the database structures and the database structures get modified when the corresponding cell gets modified.

A particular combination of values across different dimensions is shown on the screen as one or more data slices, and the data slice(s) may be filtered or combined with other data slice(s) to change a shape of the dataset being visualized, modified, or analyzed. Interaction with the user interface may change the level of the dimension being shown. For example, a double-click on quarterly-level information in the time dimension may drill down to month-level information in the time dimension. As another example, a right-click on the month-level information may roll back up to quarterly level information. The user interface allows drill-down and roll-up operations, seamlessly changing the data in view to match the level of data being viewed.

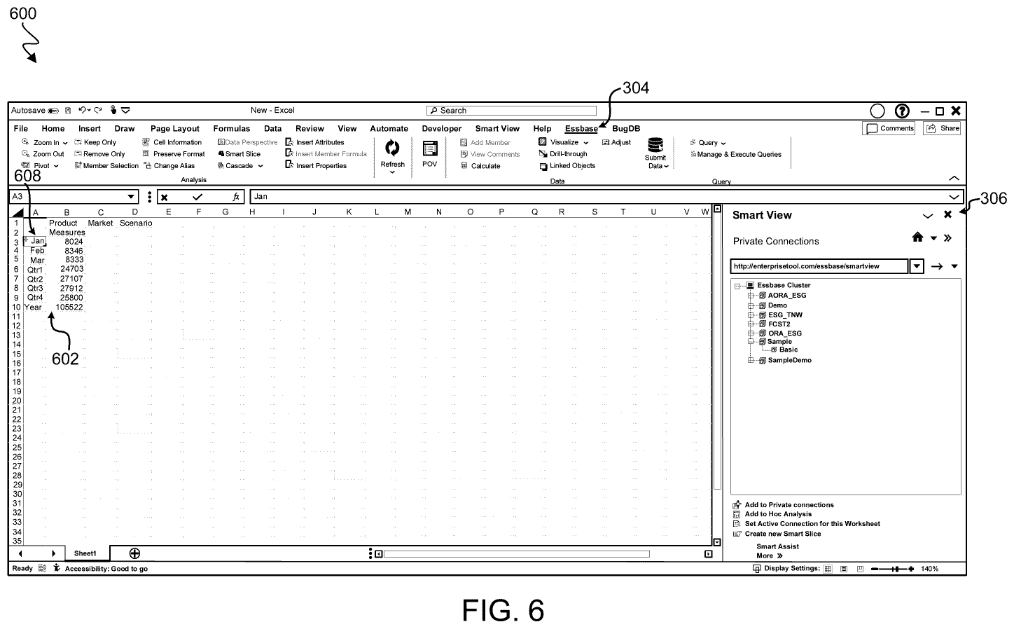

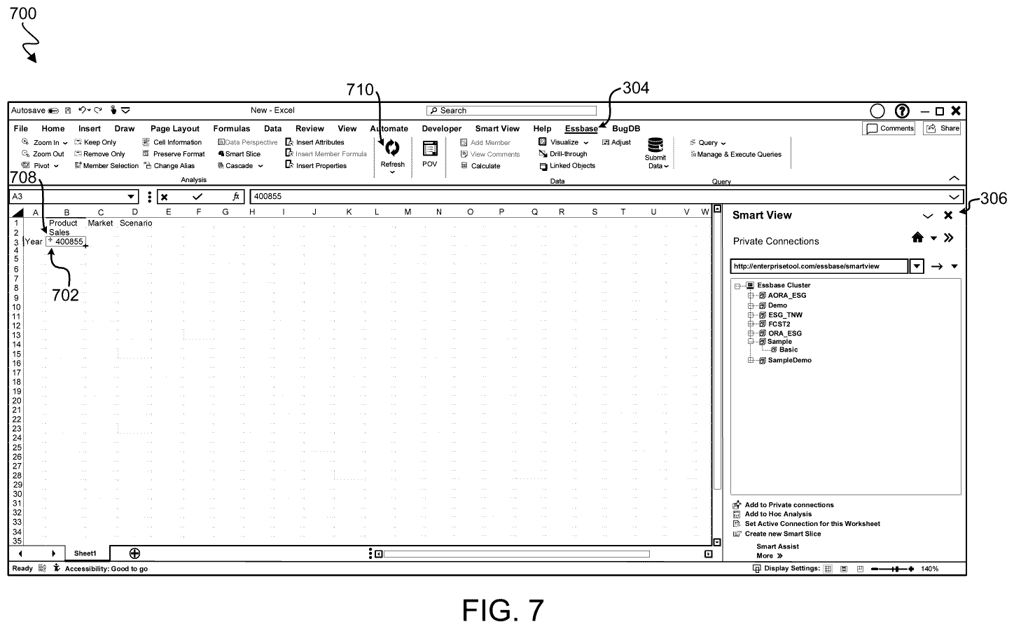

The user interface also allows new dimension members to be specified on the interface, and the grid and values shown are automatically adjusted for the dimension members specified. For example, as shown in FIGS. 6-7, the text “Sales” may be typed over “Measures” to replace measures data with sales data in the user interface, for the same other dimension level selections that have already been made according to text in other cells. As another example, “Cola,” “New York,” and “Actual” can be typed over “Product,” “Market,” and “Scenario” to replace the sales data shown to drill into Cola products in market New York for only the actuals scenario.

If the user does not know the members in the hierarchy, the user may search for members using a member selector. Once the user finds the appropriate member, the member may be typed into the interface to change the view to cover different data slices.

### Intelligently Prompting about Interface Functionality and Data Dimensionality

Various embodiments are described herein with respect to multidimensional data, for example, where dimensions are shown or modified or charts are created or modified to represent dimensions. Any such embodiments may also be implemented without multidimensional data, where data schemas are represented to the LLM, available UI functionality is represented in structured objects, and UI functionality is triggered based on user-provided natural language requests.

In various embodiments, a selected or shown data element, multidimensional or not, may be interacted with in natural language, for example, via a chat region. The data element may be dynamic in the sense that the data element may be changed or modified according to certain user interface operations while still being shown, and/or modified by changing its underlying value. For example, the data item may be drilled into, rolled up, aggregated, summed, or otherwise analyzed or processed based on the natural language. The natural language may refer to the data element and cause one or more UI operations to be performed against the data element by using an LLM to generate a structured object, which is used to pass an executable structured object into the application for triggering functionality aligned with the natural language.

In various embodiments, an LLM is prompted to generate a data structure that uses a multidimensional expression language (MDX) to retrieve or modify data to use for triggering application functionality. The multidimensional expression language statement may be used to query data. For example, a natural language “Give me the top 5 markets,” is transformed by the LLM into an MDX expression along with a data structure for showing data items that result from execution of the MDX expression against a multidimensional dataset. Queries may be added to the LLM response to cause additional steps to be performed in processing the response before the data structure is finalized and sent to the application for execution and triggering of a change in the user interface.

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated based on user-provided natural language requests, but the prompts include more information such as data and result specification guidance than the user-provided natural language requests. The user may submit natural language commands via voice or text, for example, in a chat region. The application may convert speech-to-text and use the techniques herein on the text transcription. The application may provide requests in different languages, and the LLM may understand requests from different languages to trigger data display, visualization, manipulation, and/or other user interface operations using the API commands made available by the application as described via structural data input in the prompt. In one embodiment, inputs are converted to a base language (e.g., English) before being sent to the LLM. In another embodiment, the native language is sent to the LLM before providing a native language response but using a base language for API commands. For example, the summary on the API may be supplied by the LLM in the native language in which the request was provided.

In various embodiments, prompts are generated to use information about a data schema of multidimensional data available in a user session with an application. The data schema may include dimension names (e.g., Scenario, Market, Year, Product, and Measures), member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The data schema may describe data having different hierarchical levels, and a corresponding interface may display a view of slice(s) of data at a drill-down level selected by the large language model based on available dimensions, members, and/or values specified in the prompt. Action(s) may be performed on the view, and/or other filter(s) may be applied to drill-up or drill-down to exclude one or more dimension values for one or more dimensions that correspond to a different drill-down level than dimension(s) shown as included.

In various embodiments, prompts are generated to use examples to map natural language commands to existing user interface functionality as well as constraining the schema to a set of dimensions and members available on which the user interface may operate.

The prompts may also specify a format for providing the reply, through examples and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In various embodiments, the natural language request may include requests for multiple operations to be performed in the UI, and the LLM may generate a specification that triggers the multiple operations in the UI in response to a prompt that is generated based at least in part on the natural language request. In various embodiments, the specification may be referred to as a data structure or structural component in an LLM reply that references controls for a data view (e.g. grid) or visualization (e.g., charts or graphs) to be generated, a displayed representation (e.g. view or visualization) to be updated, or controls for other interface functionality to be performed. The various specifications may be variously referred to herein as structured objects, structural components, specifications, interface functionality specifications that cause interface functionality to be performed, representation generation specifications that cause representations such as views (e.g. grids) or visualizations (e.g. charts or graphs) to be generated, representation control specifications that cause actions to be performed against displayed representations, a data view specifications that cause interface functionality to be performed to control or generate views of data, and/or visualization specifications that cause interface functionality to be performed to control or generate visualizations. The various specifications include commands corresponding to the controls available for the corresponding types of objects to be controlled or generated in the user interface.

In one embodiment, a specification provided by the LLM may be executable as received, or may be validated, post-processed, or otherwise transformed into an executable form. For example, the specification may reference commands using a JSON data structure, and the commands may be executed using an API exposed by the application based on the JSON data structure. In this example, the executable form of the specification may be a call including parameters made to the API and/or a data structure or structures passed into the API, and the specification provided by the LLM may be a data structure in which the parameters are defined. In another example, the data structure provided by the LLM may be a JSON data structure that is directly consumable by the application. In this example, the “executable data structure” is the same as the data structure provided by the LLM, optionally with or without transformation or post-processing.

In one embodiment, the LLM provides a response to the prompt that includes a structured object that defines a specification for viewing or manipulating data, triggering an operation, or viewing or manipulating a visualization on a user interface. The structured object may be processed to map the components of the structured object to triggerable user interface components, if any updates need to be made to formulate a valid request, and send the valid request to the application to trigger the functionality. For example, the client may perform the validation and/or other processing of the LLM result and trigger the functionality on a server that provides functionality for the application. The server generates or updates a view of data to be displayed in the application by the client.

In one embodiment, validating the structural components referenced in the LLM reply includes performing a semantic search or cosine similarity comparison of the semantic vector embeddings for the actual words used in the structural components of the application and the LLM-proposed components for use in the reply. If the LLM component is similar but invalid, the client or application may validate the result after substituting the LLM-proposed component with the actual word used in the structural components of the application rather than the word used in the LLM reply. In this manner, any invalid reference may be replaced with a corresponding most relevant valid reference. Substitutions may be made for dimensions, dimensional members, values, and/or actions provided by the LLM based on valid lists of dimensions, dimensional members, values, and/or actions. For example, “Sept” may be replaced with “Sep.” if the month of September is referenced in the application using the 3-letter abbreviation rather than the 4-letter abbreviation. As another example, “Manhattan” may be replaced with “New York” or “New York City” if the application uses state-level or city-level data but not borough-level data.

In various embodiments, the application may provide a configuration interface to the user for configuring whether near matches or non-exact matches or rough matches are used when the LLM does not provide an exact match. The configuration interface may use a sliding scale or graded indicator for the user-specification of how aggressively the LLM response should be attempted to be matched with existing functionality. If exact matches are required by the user configuration, the application may return a message indicating that the requested member does not exist.

In one embodiment, near matches are color-coded in a reply or in the user interface to indicate that the near matches were not exact matches. The user may clear the color coding via a natural language request for the chat, or the chat may ask the user if the user wishes to clear the color coding of the member names that were not exactly matched in the LLM reply. In another example, another graphical indication on the near matches is used to indicate that they are near matches, such as a strikethrough of the user-specified text or the LLM-provided term in the response and/or an underline of replacement values that were used instead of the user-specified text or the LLM-provided term in the response.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

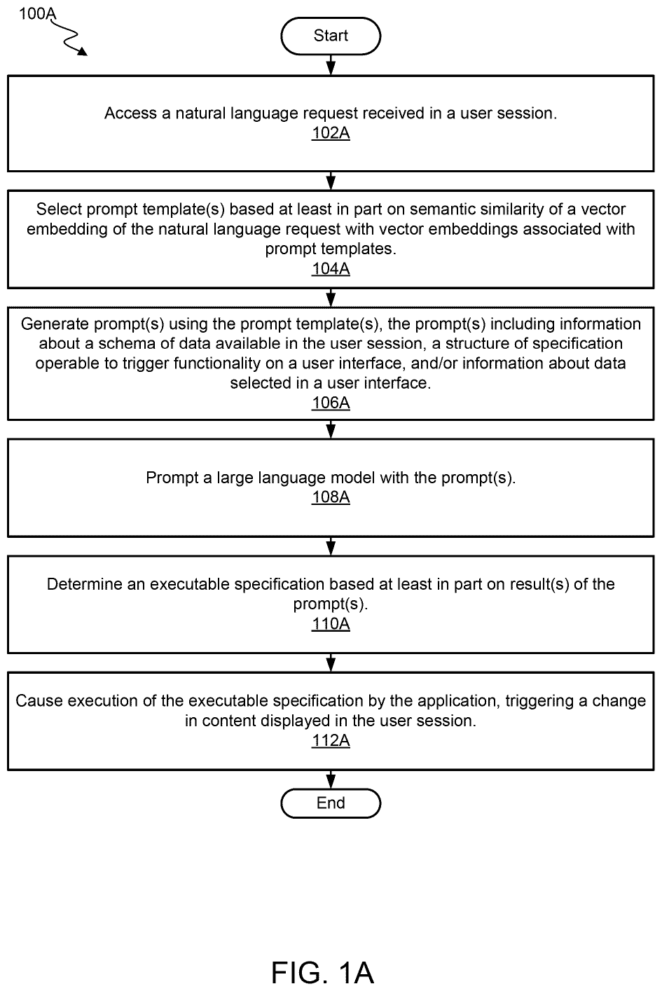

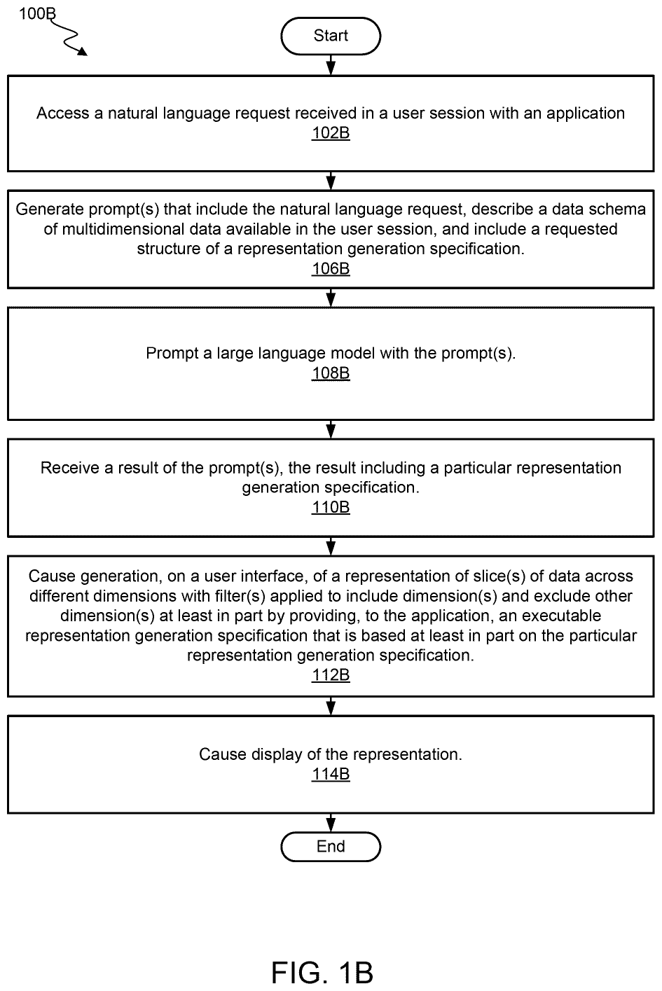

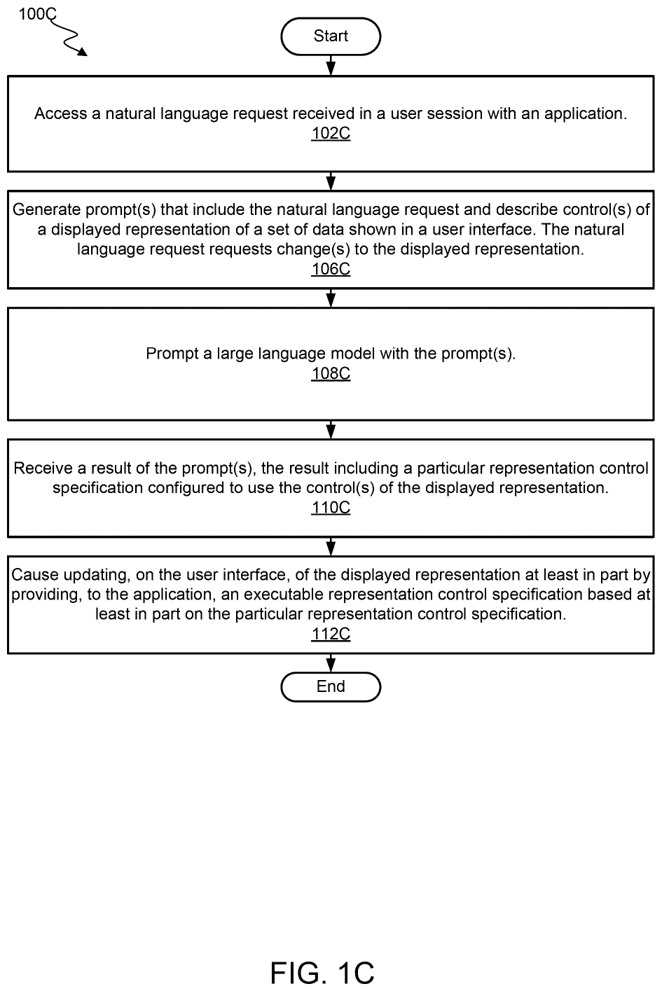

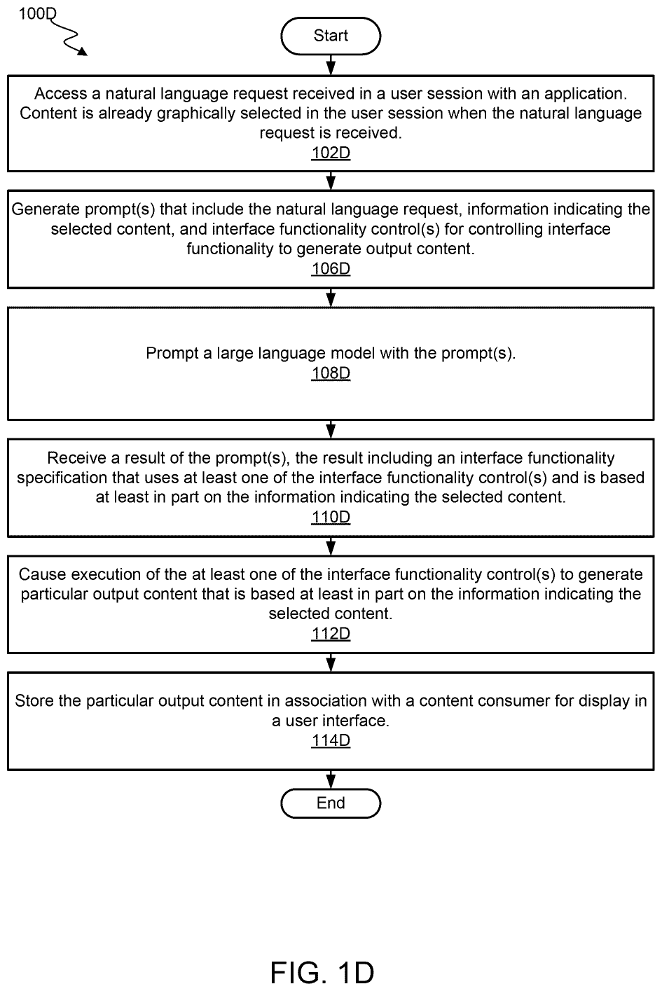

FIG. 1A illustrates a flow chart of an example process 100A that triggers functionality on data to be generated in a user interface and/or data shown or visualized in a user interface based on a natural language request that references actions to be performed and data items to use in performing the actions. As shown, in block 102A, a natural language request that is received in a user session is accessed. In block 104A, prompt template(s) are selected based at least in part on semantic similarity of a vector embedding of the natural language request with vector embeddings associated with prompt templates. Other heuristics based on conditions to be satisfied or mapping rules for different prompt templates may also or alternatively be used to select prompt template(s). In block 106A, prompt(s) are generated using the prompt template(s), the prompt(s) including information about a schema of data available in the user session, a structure of specification operable to trigger functionality on a user interface, and/or information about data selected in a user interface. In block 108A, a large language model is prompted with the prompt(s). In block 110A, an executable specification is determined based at least in part on result(s) of the prompt(s). In block 112A, execution is caused for the executable specification against the application, triggering a change in content that is displayed in a user session.

FIG. 1B illustrates a flow chart of an example process 100B that causes generation of a representation of slice(s) of data across different dimensions with filter(s) applied to include some dimension(s) and exclude other dimension(s). As shown, in block 102B, a client accesses a natural language request that is received in a user session with an application. In block 106B, prompt(s) are generated that include the natural language request, describe a data schema of multidimensional data available in the user session, and include a requested structure of a representation generation specification. In block 108B, a large language model is prompted with the prompt(s). In block 110B, the client receives a result of the prompt(s), the result including a particular representation generation specification. In block 112B, the client causes generation, on a user interface, of a representation of slice(s) of data across different dimensions with filter(s) applied to include dimension(s) and exclude other dimension(s) at least in part by providing, to the application, an executable representation generation specification that is based at least in part on the particular representation generation specification. In block 114B, the client causes display of the representation.

FIG. 1C illustrates a flow chart of an example process 100C that causes updating a displayed representation using control(s) of the displayed representation. As shown, in block 102C, a client accesses a natural language request that is received in a user session with an application. In block 106C, prompt(s) are generated that include the natural language request and describe control(s) of a displayed representation of a set of data shown in a user interface. The natural language request requests change(s) to the displayed representation. In block 108C, a large language model is prompted with the prompt(s). In block 110C, the client receives a result of the prompt(s), the result including a particular representation control specification configured to use the control(s) of the displayed representation. In block 112C, the client causes updating, on the user interface, of the displayed representation at least in part by providing, to the application, an executable representation control specification based at least in part on the particular representation control specification.

FIG. 1D illustrates a flow chart of an example process 100D that generates output content that is derived from selected content and stored for use by a content consumer. As shown, in block 102D, a client accesses a natural language request that is received in a user session with an application. Content is graphically already selected in the user session when the natural language request is received. In block 106D, prompt(s) are generated that include the natural language request, information indicating the selected content, and interface functionality control(s) for controlling interface functionality to generate output content. In block 108D, a large language model is prompted with the prompt(s). In block 110D, the client receives a result of the prompt(s), the result including an interface functionality specification that uses at least one of the interface functionality control(s) and is based at least in part on the information indicating the selected content. In block 112D, execution is caused for the at least one of the interface functionality control(s) to generate particular output content that is based at least in part on the information indicating the selected content. In block 114D, the client stores the particular output content in association with a content consumer for display in a user interface.

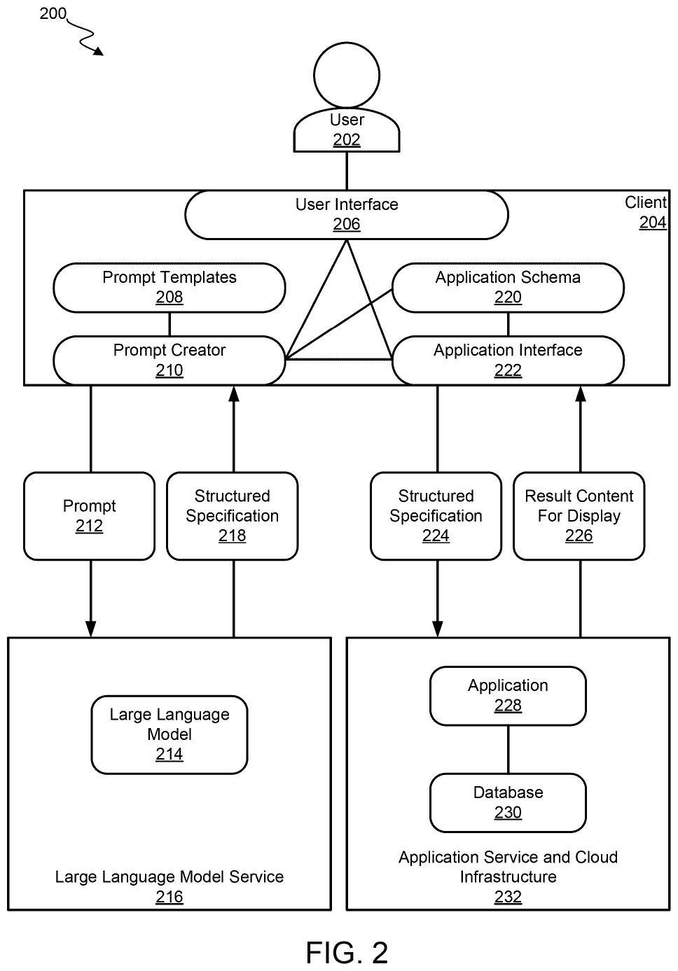

FIG. 2 illustrates a system 200 diagram showing an example cloud infrastructure that triggers functionality on data to be generated in a user interface and/or data shown or visualized in a user interface based on a natural language request that references actions to be performed and data items to use in performing the actions. As shown, user 202 interacts with user interface 206 running on client 204. User 202 may submit a natural language request, which prompt creator 210 uses to create a prompt 212 based on prompt templates 208 and/or application schema 220.

In the example shown in FIG. 2, the prompt creator 210 executes on client 204 to prompt large language model service 216. In various other embodiments, prompt creator 210 may execute on application service and cloud infrastructure 232 to prompt large language model service 216 and/or in a distributed manner across client 204 and application service and cloud infrastructure 232. In such embodiments, prompt templates 208 and/or application schema 220 may be stored on client 204, application service and cloud infrastructure 232, or shared between client 204 and application service and cloud infrastructure 232. If application service and cloud infrastructure 232 prompts large language model 214 of large language model service 216, the structured specification 218 may be returned to application service and cloud infrastructure 232 and used directly to generate result content for display 226.

Large language model 214 of large language model service 216 receives the prompt and provides structured specification 218 in response. Once the structured specification 218 is returned from the large language model 214, the client 204 or application service and cloud infrastructure 232 or any other system handling the structured specification 218 calls a data source to search for either an exact match of the extracted entities or a semantic search of the entities in the structured specification. The system handling the structured specification 218 may substitute near matches (based on semantic search or cosine distance of content vector embeddings) of the available specification of commands and parameters from the application with exact counterparts of the available specification of commands to ensure that the structured specification 218, as modified, correctly executes against application service and cloud infrastructure 232.

The structured specification 224 as potentially modified is ingested or further processed by application service and cloud infrastructure 232 to trigger application functionality, which may include sending result content for display 226 to client device. Structured specification may be processed and provided to application interface 222 for submission to application service and cloud infrastructure 232 as structured specification 224 for execution against application 228. Result content for display 226 is provided back to application interface 222, which provides updates content displayed on user interface 206.

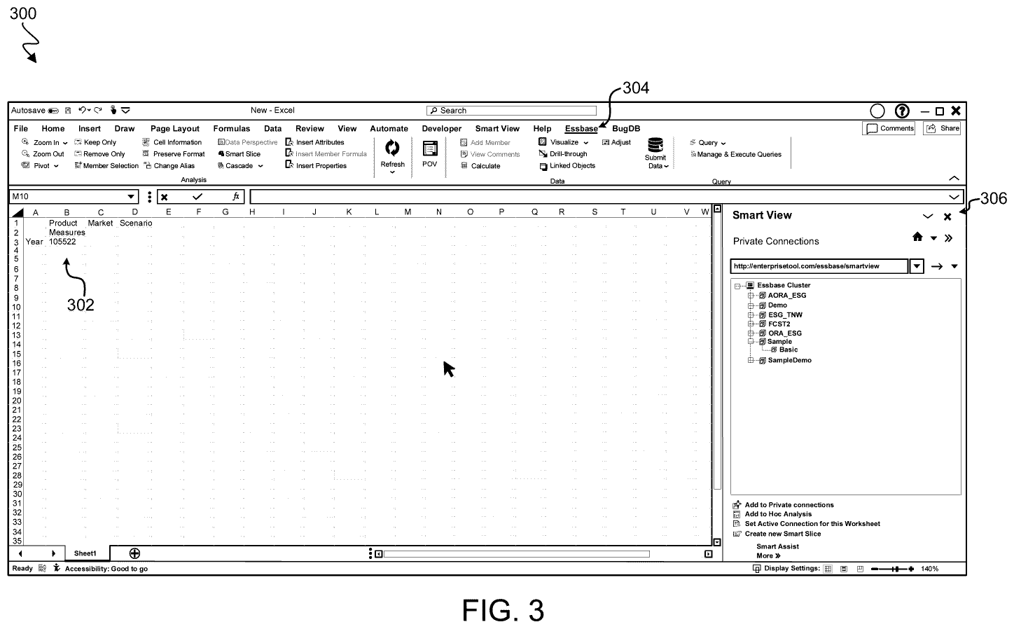

FIG. 3 illustrates an example user interface 300 showing multidimensional data view 302 that can be drilled into and then rolled up. In the example shown, the multidimensional data view 302 is accessible via an Essbase® plugin 304 to Microsoft Excel®. User interface 300 includes an interaction region 306 where dimensional data sets are selectable for inclusion among the multidimensional data view 302 that can be navigated via interface 300.

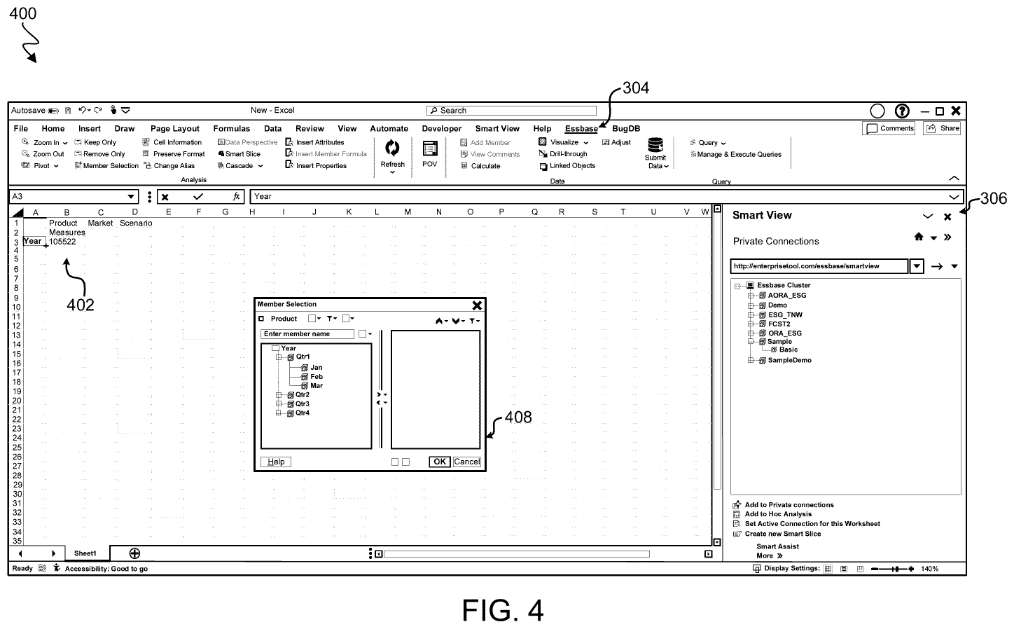

FIG. 4 illustrates an example user interface 400 showing various members of a Product dimension hierarchy that can be drilled into or rolled up to. As shown in member selection tool 408, dimensional members may be selected or de-selected for inclusion in multidimensional data view 402.

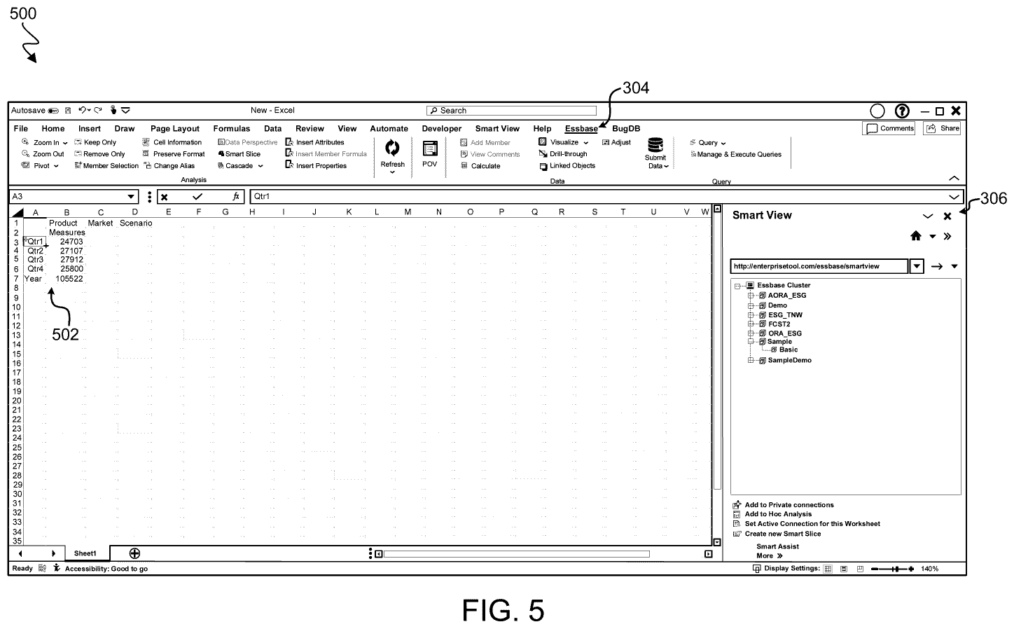

FIG. 5 illustrates an example user interface 500 showing, in multidimensional data view 502, a result of drilling down to the Quarter level of the time dimension.

FIG. 6 illustrates an example user interface 600 showing, in multidimensional data view 602, a result of drilling down to the Month level of the time dimension, with month-specific data 608 shown.

FIG. 7 illustrates an example user interface 700 showing, in multidimensional data view 702, a result of changing Measures to Sales by typing into a cell 708 managing the Measures or Sales dimension, and selecting a refresh option 710 to update multidimensional data view 702.

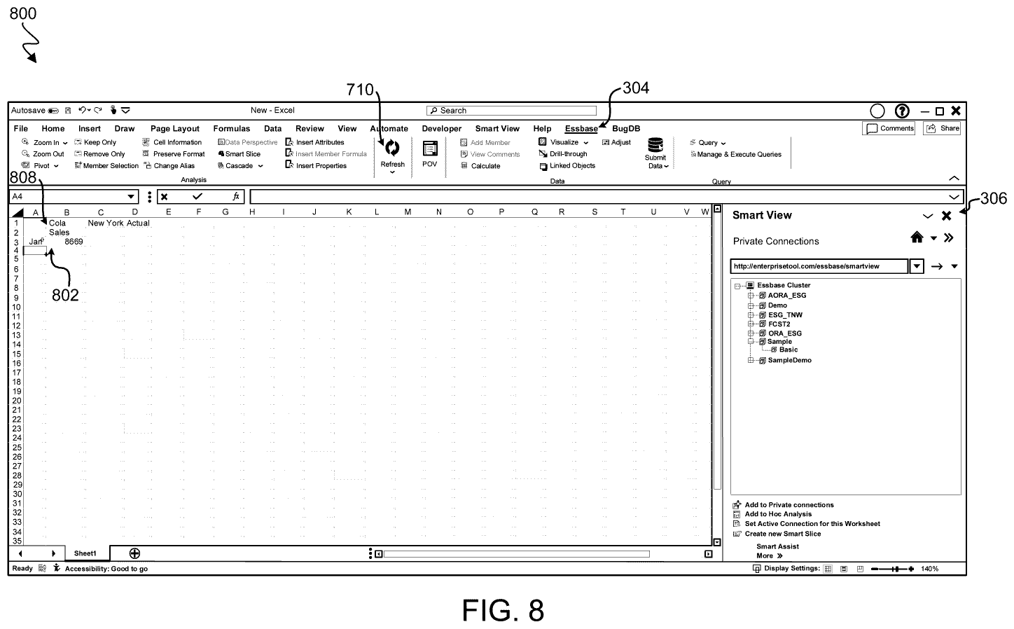

FIG. 8 illustrates an example user interface 800 showing, in multidimensional data 802, a result of typing into cells 808, Cola, New York, and Actual as the Product, Market, and Scenario intersection shown in the grid, and selecting refresh option 710 to update multidimensional data view 802.

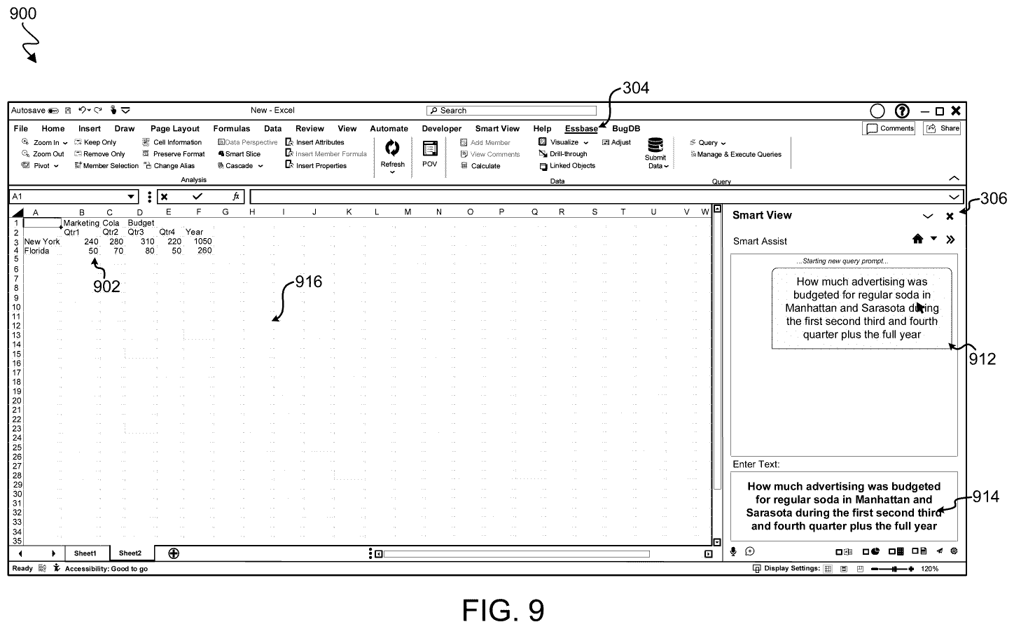

FIG. 9 illustrates an example user interface 900 showing a result of typing in “How much advertising was budgeted for regular soda in Manhattan and Sarasota during the first second third and fourth quarter plus the full year?” into input region 914 of the chat region or interaction region 306, with the main region 916 of the interface 900 showing the grid or view 902 changing accordingly pursuant to interaction with an LLM and execution of a corresponding action. Chat history is shown in interaction region 306, including history 912 of input received and processed.

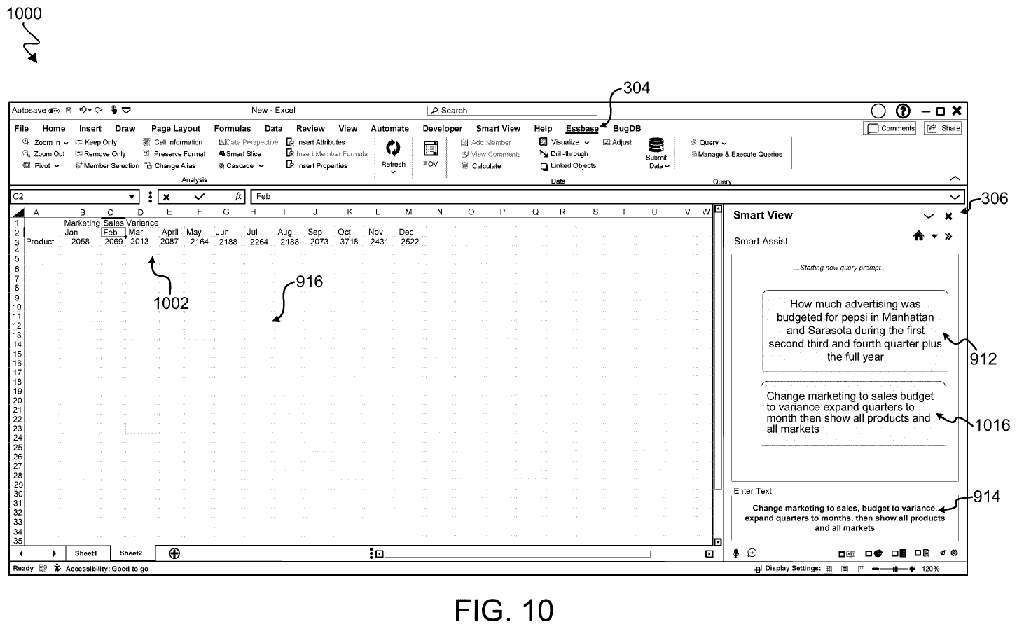

FIG. 10 illustrates an example user interface 1000 showing a result of typing in “Change marketing to sales, budget to variance, expand quarters to months then show all products and all markets” into input region 914 of the chat region or interaction region 306, with the main region 916 of the interface 900 showing the grid or view 1002 changing accordingly pursuant to interaction with an LLM and execution of a corresponding action. Chat history is shown in interaction region 306, including histories 912 and 1016 of input received and processed.

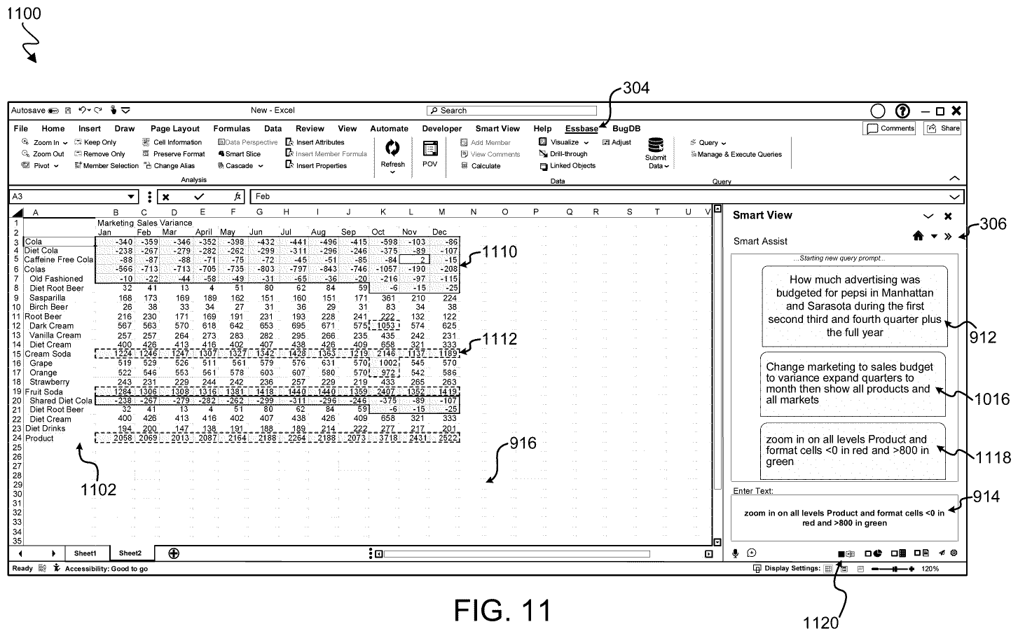

FIG. 11 illustrates an example user interface 1100 showing a result of typing in “Zoom in on all levels Product and format cells <0 in red and >800 in green” into input region 914 of the chat region or interaction region 306 with a grid checkbox 1120 checked, with the main region 916 of the interface 900 showing the grid 1102 changing accordingly pursuant to interaction with an LLM and execution of a corresponding action. As shown with shading and a solid line, cells 1110 have been highlighted in red due to conditional formatting applied from processing the user request and values falling below zero. As shown with shading and a dashed line, cells 1112 have been highlighted in green due to conditional formatting applied from processing the user request and values occurring above 800. In this manner, data items may have different formats applied based on control parameters (e.g., the conditional formatting control that uses the specified formatting conditions such as “less than zero” and “greater than 800”) determined from the natural language request and available control(s) specified in the prompt. Chat history is shown in interaction region 306, including histories 912, 1016, and 1118 of input received and processed.

Display setting(s) of a displayed representation, such as a view or visualization, may be modified, such as a location of where the displayed representation is to be displayed, a color, size, or other characteristic of the displayed representation that goes beyond conditionally formatted values. The display setting(s) may be modified by the LLM according to a specification that controls the displayed representation using, for example, control(s) that were specified in the prompt to the LLM. In this manner, a display setting of a displayed representation may vary from before update by the LLM to after update by the LLM.

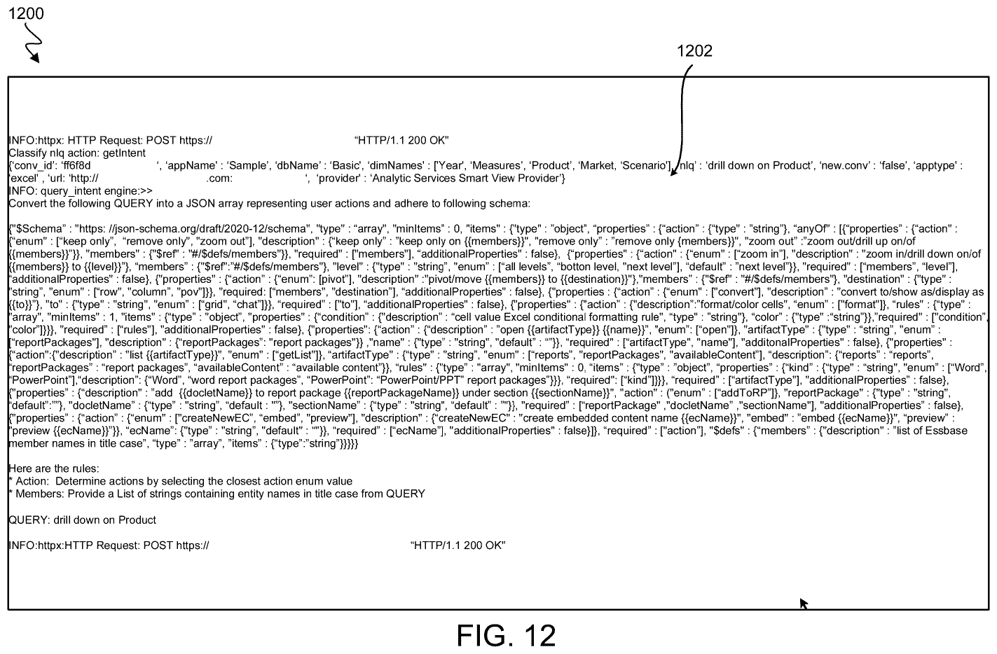

FIG. 12 illustrates an example file including a schema 1202, text from which may be included in a large language model prompt to cause the large language model to trigger functionality against data accessible via the application and using interface functionality available in the application. As shown in the example, actions may be triggered including keeping only certain members, removing only certain members, zooming out/drilling up on, zooming in/drilling down on, zooming to a specified level, showing all levels, a bottom level, a top level, or a next level, pivoting on certain members, converting data or showing or displaying data in a different way, returning results to the grid or chat, applying conditional formatting to certain cells or ranges of cells, opening a file, creating a report or report package, adding to a report or report package or other target object, opening output in Microsoft Excel®, Microsoft Word®, Microsoft PowerPoint®, or another application, creating and/or showing a document or a section of a document, embedding content, previewing content, etc.

In various embodiments, output content may be generated by the LLM for consumption by any content consumer, whether the content consumer is the same application or a different application, or a particular component of an interface of the same application or a different application. The LLM may be provided with controls for triggering display of the output by the corresponding consumer, and the controls may be used to generate an interface functionality specification for causing data or representation transformation(s) and/or display(s) as output to one or more consumers. The output may be executable as provided by the LLM or subject to validation, transformation, or other post-processing before being executed against the content consumer. In one example, the output is executable to cause instantiation of another application with the output content loaded into the other application. For example, a summary may be loaded into a newly opened instance of Microsoft PowerPoint®.

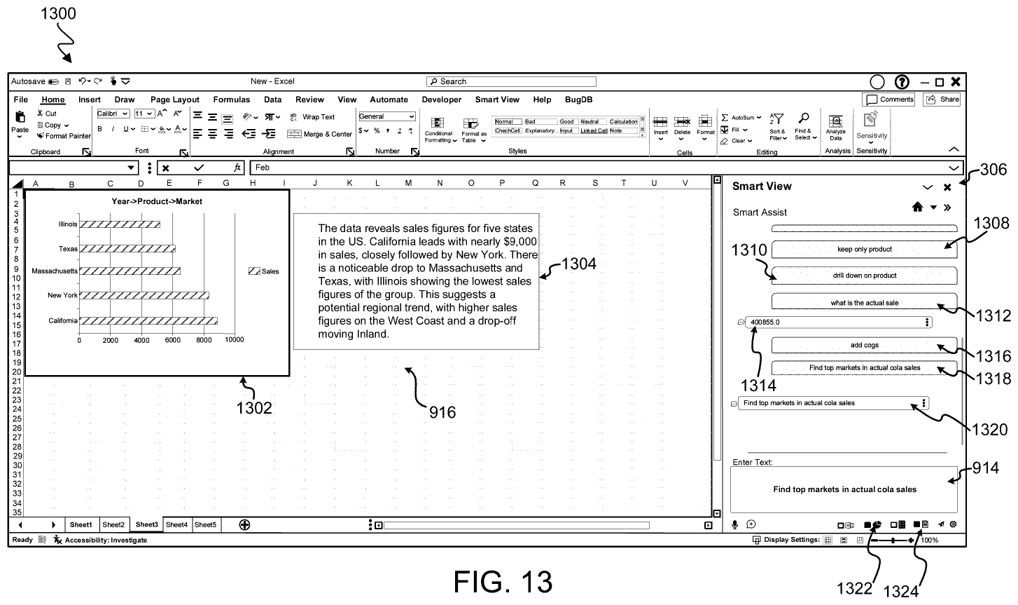

FIG. 13 illustrates an example user interface 1300 showing a result of typing in “Find top markets in actual cola sales” into input region 914 of the chat region or interaction region 306 with a visualization checkbox 1322 and a summary checkbox 1324 checked, with the main region 916 of the interface 1300 showing a visualization 1302 and summary 1304 generated accordingly pursuant to interaction with an LLM and execution of a corresponding action. Chat history is shown in interaction region 306, including histories 1308, 1310, 1312, 1314, 1316, 1318, and 1320. In the example, histories 1312 and 1314 show a past natural language input that resulted in output of a resulting value to the chat session in interaction region 306 rather than update to the grid in main region 916.

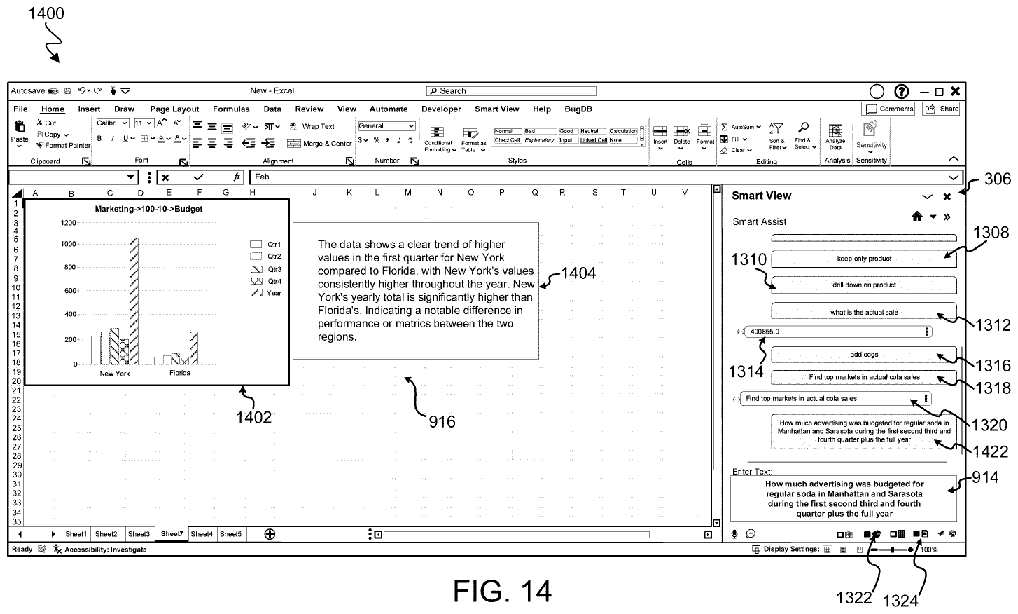

FIG. 14 illustrates an example user interface 1400 showing a result of typing in “How much advertising was budgeted for regular soda in Manhattan and Sarasota during the first second third and fourth quarter plus the full year” into input region 914 of the chat region or interaction region 306 with a visualization checkbox 1322 and summary checkbox 1324 checked, with the main region 916 of the interface showing a visualization 1402 and summary 1404 generated accordingly pursuant to interaction with an LLM and execution of a corresponding action. Chat history is shown in interaction region 306, including histories 1308, 1310, 1312, 1314, 1316, 1318, 1320, and 1422.

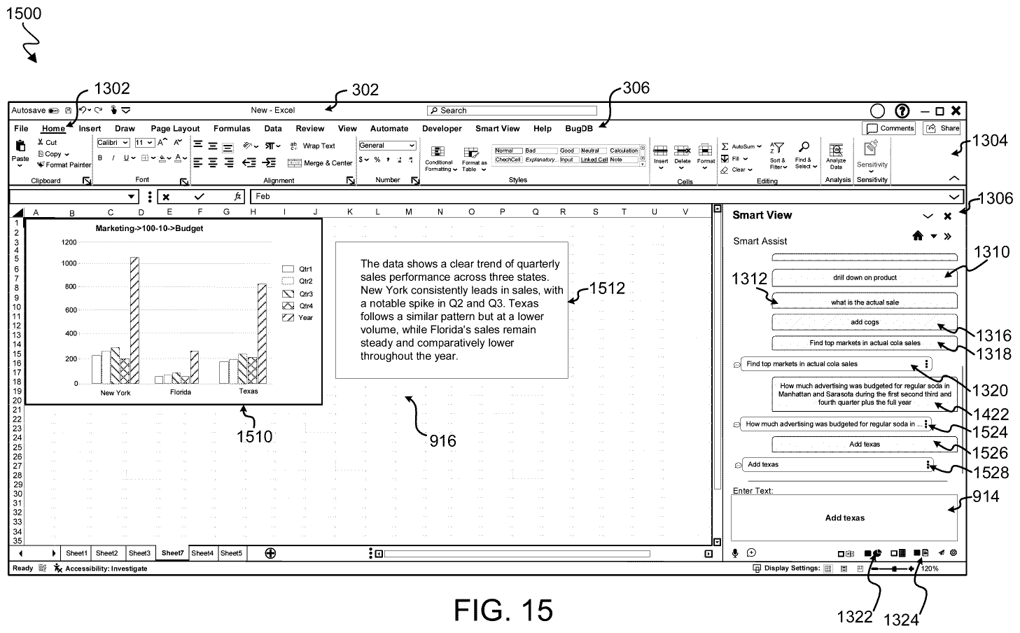

FIG. 15 illustrates an example user interface 1500 showing a result of typing in “Add texas” into input region 914 of the chat region or interaction region 306 with a visualization checkbox 1322 and summary checkbox 1324 checked, with the main region 916 of the interface showing the visualization 1510 changing accordingly pursuant to interaction with an LLM and execution of a corresponding action. Chat history is shown in interaction region 306, including histories 1310, 1312, 1316, 1318, 1320, 1422, 1524, 1526, and 1528. As shown, histories 1320, 1524, and 1528 include additional options selectable on an edge of each of histories 1320, 1524, and 1528, to cause display of the result in various forms (e.g., data views, visualizations, reports), interface regions, or different applications (e.g., Microsoft Word® or Excel®).

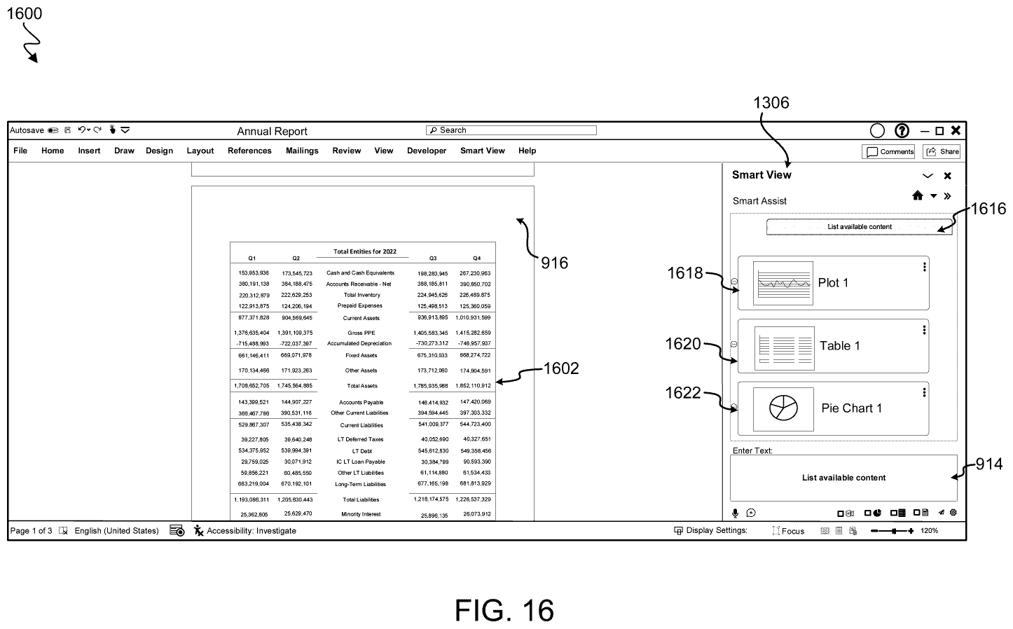

FIG. 16 illustrates an example user interface 1600 showing a result of typing in “List available content” into input region 914 of a chat region or interaction region 306, with thumbnails 1618, 1620, and 1622 of available content and visualizations showing up in a scrollable chat region or interaction region 306 pursuant to interaction with an LLM and execution of a corresponding action. Chat history is shown in interaction region 306, including history 1616 and selectable responses that include thumbnails 1618, 1620, and 1622. The available content shown as 1618, 1620, or 1622 may be applied to data 1602 shown in main region 916.

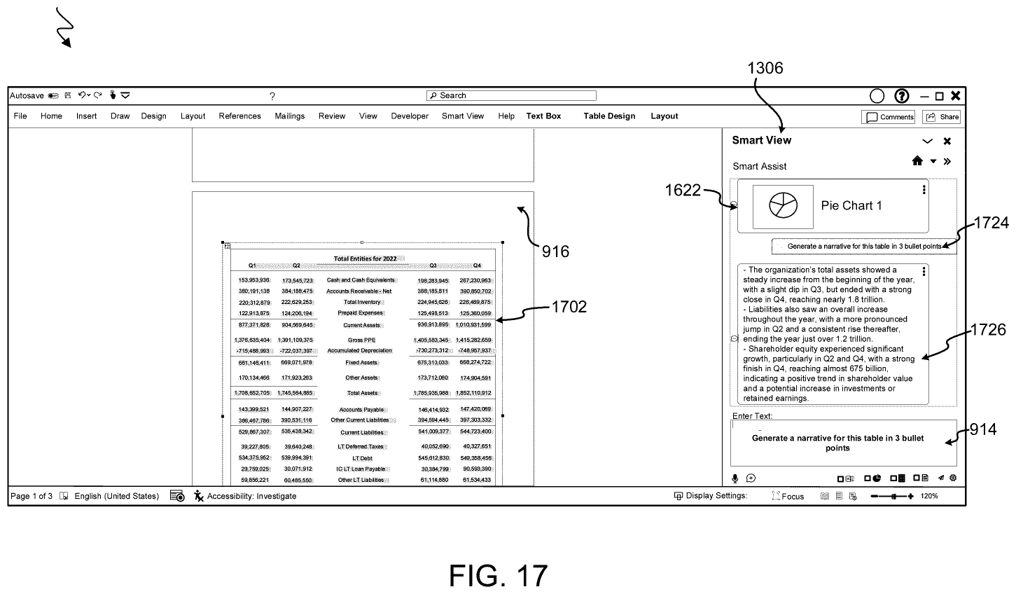

FIG. 17 illustrates an example user interface 1700 showing a result of selecting content 1702 in main region 916 of the user interface 1700 and typing “Generate a narrative for this table in 3 bullet points” into the input region 914 of the chat region or interaction region 306, with a narrative response 1726 generated in the chat region or interaction region 306 pursuant to interaction with an LLM and execution of a corresponding action. Chat history is shown in interaction region 306, including history 1622, 1724, and 1726.

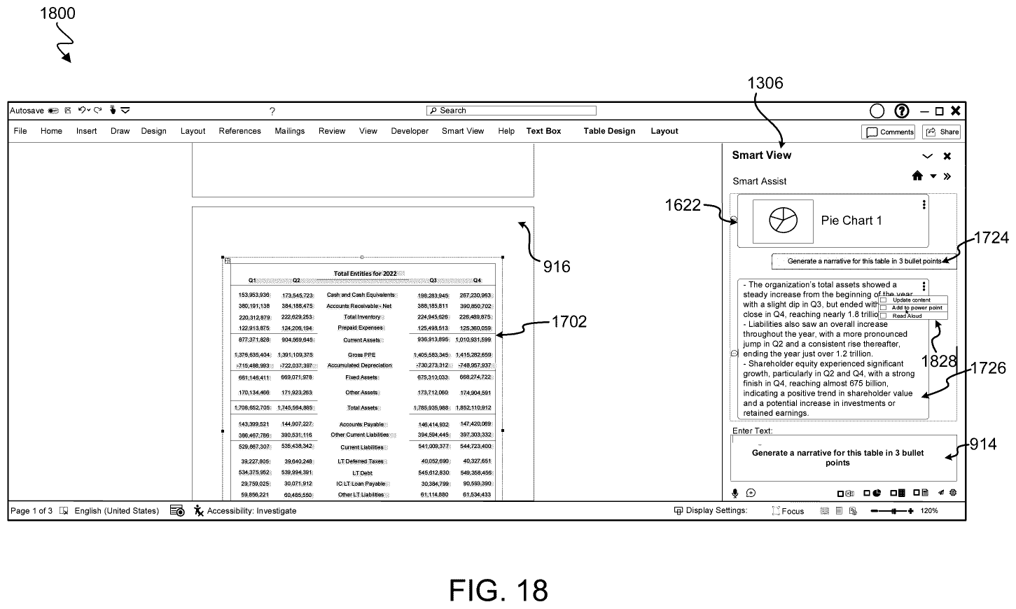

FIG. 18 illustrates an example user interface 1800 showing a selection of an “Add to Power Point” option among options 1828 for content 1726 displayed in the chat region or interaction region 306, with other options of options 1828 including “Update Content” and “Read Aloud,” which may be performed, for example, by interacting with an LLM and executing a corresponding action.

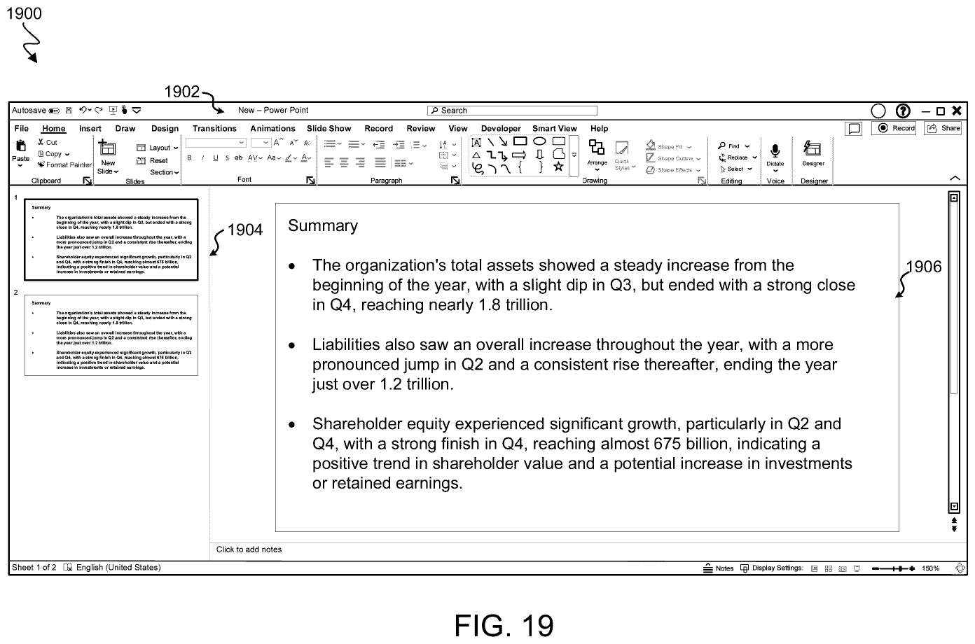

FIG. 19 illustrates an example user interface 1900 showing a result of the selection among options 1828 of FIG. 18, showing a Microsoft PowerPoint® document changing accordingly in main region 1906 and navigation region 1904 pursuant to interaction with an LLM and execution of a corresponding action.

### Intelligently Generating a Multi-Dimensional Data View

In one embodiment, a computer-implemented method comprises accessing a natural language request received in a user session with an application. The computer-implemented method further comprises generating a prompt that describes a data schema of multidimensional data available in the user session and a requested structure of a data view specification. The computer-implemented method further comprises prompting a large language model with the prompt. The computer-implemented method further comprises receiving a result of the prompt, the result comprising a particular data view specification. The computer-implemented method further comprises providing, to the application, an executable data view specification based at least in part on the particular data view specification, to generate a view, on a user interface, of one or more slices of data across different dimensions with one or more different filters applied. The computer-implemented method further comprises causing display of the view.

In an example, an application may receive, via a user interface, a natural language request that states “How much advertising was budgeted for regular soda in Manhattan and Sarasota during the first second third and fourth quarter plus the full year?” In response to the natural language request, the application may generate a prompt that includes schema from the multidimensional database schema that is available for display as well as the natural language request from the user that specifies the requested structure of a data view specification. Execution of the prompt against an LLM may return, to the application, an application-consumable view specification that instructs the application to include certain data slice(s) in a result shown on the screen. After validating that the view specification is executable against existing data slices and that the view specification uses existing user interface functionality, the application executes the application-consumable view specification to generate a view of the data slice(s) with zero, one, or more different filters applied. The application then causes display of the view for consumption, interaction, and/or further analysis (e.g., roll-up, drill-down, creation of visualizations, saving for later use in the same or a different application, inclusion in reports, printing, etc.) by the user. As shown in FIG. 9, the LLM selects a data slice that shows an intersection between marketing (based on “advertising”), cola (based on “regular soda”), budgeting (based on “budgeted”) for the region dimensions New York and Florida (based on “Manhattan” and “Sarasota”) and the time dimensions Qtr1, Qtr2, Qtr3, Qtr4, and Year (based on “for the first second third and fourth quarter plus the full year”).

In the example, the application discovers existing dimensions using current APIs. The Dimensions list is sent to a server as a prompt along with the user's natural language Query. A conversation ID is generated to link different interactions with LLM in the example that follows:
{′conv_id′: ‘79118fe9-6c08-43ca-b62b-a7044c1634b1_SVR’, ‘appName’: ‘Sample’, ‘dbName’: ‘Basic’, ‘dimNames’: [′Year′, ‘Measures’, ‘Product’, ‘Market’, ‘Scenario’], ‘nlq’: ‘How much advertising was budgeted for regular soda in Manhattan and Sarasota during the first second third and fourth quarter plus the full year’, ‘new_conv’: ‘true’, ‘appType’: ‘excel’, ‘url’: ‘http://phoenix378260.appsdev.fusionappsdphx1.oraclevcn.com: 9000/essbase/smartview’, ‘provider’: ‘Analytic Services Smart View Provider’}

Then, the following prompt may be sent to the LLM endpoint along with few shot examples listed as “Example #”
INFO:data_query: >>Use the following examples:
Example 1 ###Essbase application “Sample” with “Basic” database. It has an outline with 5 dimensions: “Year”, “Product”, “Market”, “Scenario”, “Measures”.
To “get the budgeted sales for Cream soda in New York during January”, identify the dimensions and members that need to be present in the report.
Please answer in JSON machine-readable format, using key: value pairs—{dimension name} and {array of members}. Format the output as JSON object. Make sure that it is properly closed at the end. If members cannot be ascertained, leave the member list empty. Neither provide additional comments nor ask follow up questions.
answer: {“Scenario”: [“Budgeted”], “Market”: [“New York”], “Year”: [“January”], “Product”: [“Cream soda”], “Measures”: [“Sales”]}}
Example 2 ###Essbase application “Sample” with “Basic” database. It has an outline with 5 dimensions: “Year”, “Product”, “Market”, “Scenario”, “Measures”.
To “get the budgeted sales for Cream soda in all the eastern region cities during the first quarter”, identify the dimensions and members that need to be present in the report.
Please answer in JSON machine-readable format, using key: value pairs-{dimension name} and {array of members}. Format the output as JSON object. Make sure that it is properly closed at the end. If members cannot be ascertained, leave the member list empty. Neither provide additional comments nor ask follow up questions.
answer: {“Scenario”: [“Budgeted”], “Market”: [“All the eastern region cities”], “Year”: [“First quarter”], “Product”: [“Cream soda”], “Measures”: [“Sales”]}
Use the above examples to answer the following test case: ###Essbase application “Sample” with “Basic” database. It has an outline with 5 dimensions: Year, Measures, Product, Market, Scenario.
To “How much advertising was budgeted for regular soda in Manhattan and Sarasota during the first second third and fourth quarter plus the full year”, identify the dimensions and members that need to be present in the report.

In the example, the LLM resolves the members to corresponding dimensions and responds as follows:
INFO:httpx:HTTP Request: POST https://api.cohere.com/v1/chat “HTTP/1.1 200 OK”
INFO:data_query: <<{
   “Scenario”: [
      “Budgeted”
   ],
   “Market”: [
      “Manhattan”,
      “Sarasota”
   ],
   “Year”: [
      “First Quarter”,
      “Second Quarter”,
      “Third Quarter”,
      “Fourth Quarter”,
      “Full Year”],
   “Product”: [
   “Regular Soda”
   ],
   “Measures”: [
      “Advertising”
   ]
}

The response from the LLM is sent to a schema resolution service to match, based on embeddings, the actual member from the response:
INFO:data_query:JSON string:
{“Scenario”: [“Budgeted”], “Market”: [“Manhattan”, “Sarasota”], “Year”: [“First Quarter”, “Second Quarter”, “Third Quarter”, “Fourth Quarter”, “Full Year”], “Product”: [“Regular Soda”], “Measures”: [“Advertising”
=====================llm embedding===========
[‘Budgeted’, ‘Manhattan’, ‘Sarasota’, ‘First Quarter’, ‘Second Quarter’, ‘Third Quarter’, ‘Fourth Quarter’, ‘Full Year’, ‘Regular Soda’, ‘Advertising’]
=====================llm embedding End===========

The schema resolution service determines actual members from the embeddings.
INFO:httpx:HTTP Request: POST https://api.cohere.com/v1/embed “HTTP/1.1 200 OK”
   Budgeted=>Budget
   Manhattan=>New York
   Sarasota=>Florida
   First Quarter=>Qtr1 (Quarter1)
   Second Quarter=>Qtr2 (Quarter2)
   Third Quarter=>Qtr3 (Quarter3)
   Fourth Quarter=>Qtr4 (Quarter4)
   Full Year=>Year
   Regular Soda=>100-10 (Cola)
   Advertising=>Marketing
INFO:werkzeug:127.0.0.1--[13/Aug/2024 15:09:58] “POST/parse_nlq HTTP/1.1” 200—

The resolved member and dimension combination is sent to the application for execution, for example to the Smart View client application. From this, the Smart View client application generates an application-specific request and retrieves data from application server. One of the sample server input is as follows:
<req_ExecuteQuery>
   <sID>f84d72c8-52d0-4b13-895a-8d001d945b3d</sID>
   <preferences/>
   <rows>
      <row Id=“0” dim=“Market”>
         <members>New York|Florida</members>
      </row>
   </rows>
   <cols>
      <col Id=“0” dim=“Year”>
         <members>Qtr1|Qtr2|Qtr3|Qtr4|Year</members>
      </col>
   </cols>
   <povs>
      <pov dim=“Measures” selectedMember=“Marketing”>
         <members>Marketing</members>
      </pov>
      <pov dim=“Product” selectedMember=“100-10″>
         <members>100-10</members>
      </pov>
      <pov dim=” Scenario” selectedMember=“Budget”>
         <members>Budget</members>
      </pov>
   </povs>
</req_ExecuteQuery>

The response from the application is then rendered in the client application for display on a client device.

In another example, a natural language request for “show me the actual sales” may return a single number such as a number in the chat session as the result of the intersection of Scenario: Actual and Measures: Sales across all dimensions without any separation of values or other specified structure for the result.

In one embodiment, a natural language request to show data may be open-ended enough that the LLM selects which dimensions are along the x-axis and which dimensions are along the y-axis in a grid view of the data. For example, the LLM may be treated as an expert in designing tables and may select where to put columns of multidimensional data in a grid. The data may be shown in one or more visualizations to provide a focus on the request being asked by the user, as determined by the LLM in generating the view specification for consumption by the application.

### Intelligently Triggering Actions in the Multi-Dimensional Data View Using Generative AI

In one embodiment, a computer-implemented method comprises accessing a natural language request received in a user session with an application. The computer-implemented method further comprises generating a prompt that describes a view of a set of data shown in a user interface and requested user interface functionality to be triggered that affects the view shown in the user interface. The computer-implemented method further comprises prompting a large language model with the prompt. The computer-implemented method further comprises receiving a result of the prompt, the result comprising a particular interface functionality specification. The computer-implemented method further comprises providing, to the application, an executable interface functionality specification based at least in part on the particular data view specification, to update, on the user interface, the view, and causing display of the updated view.

In an example, a user provides a natural language request that states “Change marketing to sales, budget to variance, expand quarters to months then show all products and all markets”. In response to the natural language request, the application generates a prompt that describes a current view of a set of data that is shown in the user interface and the natural language request that specifies what user interface functionality is requested to be triggered that affects the view shown in the user interface. Execution of the prompt against an LLM may return, to the application, an application-consumable interface functionality specification that instructs the application to include certain data slice(s) or perform certain operations on data shown on the screen. After validating that the interface functionality specification is executable against existing data slices and that the interface functionality specification uses existing user interface functionality, the application executes the application-consumable interface functionality specification to update a resulting view and cause display of the result view of applying the interface functionality specification for consumption, interaction, and/or further analysis (e.g., roll-up, drill-down, creation of visualizations, saving for later use in the same or a different application, inclusion in reports, printing, etc.) by the user. As shown in the FIGS. 9-10, the data slice shows an intersection of Market, Sales, and Variance rather than Marketing, Cola, and Budget for all products. The application changed marketing to sales, budget to variance, expanded the quarters to months, and rolled up to all products and all markets (indicated by “Market” and “Product”).

In another example, a user provides a natural language request that states “Zoom in on all levels product and format cells <0 in red and >800 in green”. In response to the natural language request, the application generates a prompt that describes a current view of a set of data that is shown in the user interface and the natural language request the specifies what user interface functionality is requested to be triggered that affects the view shown on the user interface. Execution of the prompt against an LLM may return, to the application, an application-consumable interface functionality specification that instructs the application to include perform a zoom in operation on the user interface and change cell formatting of cells shown on the user interface. After validating that the interface functionality specification is executable against existing data slices and that the interface functionality specification uses existing user interface functionality, the application executes the application-consumable interface functionality specification to update a resulting view and cause display of the result view of applying the interface functionality specification for consumption, interaction, and/or further analysis (e.g., roll-up, drill-down, creation of visualizations, saving for later use in the same or a different application, inclusion in reports, printing, etc.) by the user. As shown in the FIG. 11, the drill-down or zoom in operation was performed on all levels of product, and the cells were reformatted with a conditional formatting operation so that values below zero show up in red and values above 800 show up in green.

In the example, an action data structure (e.g., JSON) is generated that specifies action metadata including target member(s), with specified level(s), and/or with specific rule(s) or filter(s) applied, or any combination thereof, based on examples that cover actions available to be triggered in the system along with their corresponding action metadata. For example, the actions may be actions that are triggerable on a user interface via application Grid APIs or top-level commands, such as Zoom In, Zoom Out, Pivot, Keep Only, Remove Only, Format, Cascade, etc. The prompt may also identify the corresponding options on the user interface when the action is being triggered, such as, for Zoom In, “Next Level,” “All Levels,” “Bottom Level,” “Same Level,” “Sibling Level,” “Same Generation,” and “Formulas.”

An example schema is shown in the FIGS that defines different items of functionality available to the application in a structured format that is reliably consumable by the LLM. As shown, individual actions are provided in a structured format with a name of the action, a description of the action, and members of the action, optionally with rules, a destination, properties, items, formatting, and other characteristics that have a designated location for specification within the structure.

Because an LLM is being used, exact language does not need to be specified for the action or corresponding parameters. For example, a request to “drill-down” on a member or “investigate more closely” a member may also cause the LLM to select “Zoom In” as having the closest likely requested semantic meaning from the function

An example returned data structure to trigger an action may be as follows:
[
   “action”:
      “zoom in”,
      “members”: [
         “Product”
      ]
      “level”:“all levels”
   },
   {
      “action”:
      “format” “rules”:[
         {
         “condition”: “<0”,
         “color”: “red”
         },
         {
         “condition”: “>800”,
         “color”: “green”
         }
      ]
   }
]

### Intelligently Generating a Multi-Dimensional Visualization

In one embodiment, a computer-implemented method includes accessing a natural language request received in a user session with an application. The computer-implemented method further includes generating a prompt that describes a data schema of multidimensional data available in the user session and a requested structure of a visualization specification. The computer-implemented method includes prompting a large language model with the prompt. The computer-implemented method further includes receiving a result of the prompt, the result comprising a particular visualization specification. The computer-implemented method further includes providing, to the application, an executable visualization specification based at least in part on the particular visualization specification, to generate a visualization, on the user interface, of one or more slices of data across different dimensions with zero, one, or more filters applied, and causing display of the visualization.

In one example, the user may select a graphical indication that a visualization, such as a chart, and/or a summary is requested for answering the natural language request. The graphical indications may be selected at the bottom of the chat window to guide responses from the LLM to produce visualizations, text, and/or summaries. In another example, the natural language request asks for a visualization, and the request for the visualization is detected based on a semantic meaning of the request and mapped to an LLM request for a visualization along with visualization specification structure that is used for storing a resulting visualization.

In the example shown in the FIG. 13, a request for “find top markets in actual cola sales” with a visualization checkbox and a summary checkbox selected resulted in a visualization of the top five markets in sales along with a summary of the data shown in the visualization. The summary may include observations about dimensions of data that are not directly shown in the chart, or background descriptions of dimensions or members that are provided in the prompt but not visible in the chart, as well as a semantic understanding of what the data shows as determined by the LLM. As shown, the LLM has inferred that the markets represent U.S. states. Alternatively, the LLM may use the schema for market, as provided in a prompt, to determine that market members roll up to the United States.

In another example shown in the FIG. 14, a request for “How much advertising was budgeted for regular soda in Manhattan and Sarasota during the first second third and fourth quarter plus the full year” is made with the visualization and summary boxes checked. As a result, a chart with New York and Florida multidimensional data is shown corresponding to the request, and the summary includes a textual summary about the New York and Florida data being shown. The summary may be shown in a chat region, a main region, or different sub-regions of the main region (each of which is referred to herein as a “region” of the interface).

In one embodiment, the LLM is requested to select a visualization from a set of available visualizations that are passed in with the prompt. The visualization may be selected by the LLM understanding what dimensions are being requested from the query and understanding different visualizations that may have been used to show those or similar dimensions in literature or other sources.

In one embodiment, the LLM may determine from the natural language request that the visualization should have visual element(s) having graphical characteristic(s) that are determined by value(s) of slice(s) of a set of data either displayed or determined from the natural language request. In this embodiment, an executable representation generation specification assigns the value(s) of the slice(s) of the set of data to the graphical characteristic(s) of the visual element(s). For example, the executable representation may specify that a size, extent, weight, or other graphical characteristics of a graphic, bar, column, pie chart portion, line, or other visual element should be determined by a particular value of a particular slice of data.

### Intelligently Modifying a Multi-Dimensional Visualization

In one embodiment, a computer-implemented method includes accessing a natural language request received in a user session with an application. The computer-implemented method further includes generating a prompt that describes a visualization of a set of data shown in a user interface and requested user interface functionality to be triggered that affects the visualization shown in the user interface. The computer-implemented method further includes prompting a large language model with the prompt. The computer-implemented method includes receiving a result of the prompt, the result comprising a particular visualization specification. The computer-implemented method further includes providing, to the application, an executable visualization specification based at least in part on the particular visualization specification, to update, on the user interface, the visualization, and causing display of the updated visualization.

In one example, the user may select a graphical indication that a visualization, such as a chart, and/or a summary is being modified by the natural language request. The graphical indications may be selected at the bottom of the chat window to guide responses from the LLM to produce or update visualizations, text, and/or summaries. In another example, the natural language request refers to a visualization, and the request for the visualization is detected based on a semantic meaning of the request and mapped to an LLM request for an updated visualization along with visualization specification structure that is used for storing the updated visualization.

In another example shown in the FIG. 15, a request for “Add texas” is made with the visualization and summary boxes checked. As a result, the chart with New York and Florida multidimensional data is shown with Texas added, corresponding to the request, and the summary is updated to include a textual summary about the Texas, New York, and Florida data shown.

In various embodiments, the visualization may be modified when data defining the visualization changes. The amounts or quantitative values shown on the visualization may change, but the LLM, in choosing the visualization specification to send to the application, may also choose a new type of visualization that is judged to be better for displaying the new shape of data. The new visualization may replace the old visualization on the user interface.

Example types of visualizations include, but are not limited to, charts with variables on the left, right, top, or bottom, column charts, bar charts, line charts, area charts, pie charts, doughnut charts, scatter plots, bubble plots, radar charts, waterfall charts, treemaps, sunburst charts, histograms, and box plots. Based on how similar data may have been shown in the past in documentation on which the LLM was trained, or descriptions of the various chart types and orientations or configurations and what the chart types and orientations or configurations are useful for, the LLM may select a chart type, orientation, or configuration applicable to the data being shown.

In one embodiment, the LLM may determine from the natural language request that the visualization or other displayed representation should have visual element(s) having graphical characteristic(s) that are determined by value(s) of slice(s) of a set of data either displayed or determined from the natural language request. In this embodiment, an executable representation control specification may re-assigns the value(s) of the slice(s) of the set of data to the graphical characteristic(s) of the visual element(s). For example, the executable representation may specify that a size, extent, weight, or other graphical characteristics of a graphic, bar, column, pie chart portion, line, or other visual element should be determined by a particular value of a particular slice of data. That particular value of the particular slice of data may be a different value than was used before updating the visualization to control the graphical characteristic of the visual element. The visual element and/or graphical characteristic may be added to the visualization by the update, optionally replacing a prior visual element and/or graphical characteristic. Additionally or alternatively, the update may change the slice(s) of data shown by the visualization to include different slice(s) of data or to be filtered according to different filter(s) than before the update.

In various embodiments, the updates may be performed according to representation transformation actions that are available, on the user interface, to be performed against the displayed representation. For example, the representation transformation actions may otherwise be selectable, by a user in a user session from which the natural language request was received, to cause the representation transformation actions one-by-one in an order selected by the user. The representation transformation actions may be triggered by the LLM according to the representation control specification in an order determined by the LLM to cause the displayed representation to be modified in a manner determined by the LLM with an understanding, from the information specified in the prompt, of what control(s) are available to modify the displayed representation.

### Triggering Generative Intelligent Processing of Displayed Text Selected in a User Interface

In one embodiment, a computer-implemented method comprises accessing a natural language request received in a user session with an application. Text is selected in the user session when the natural language request is received. The computer-implemented method further includes generating a prompt that describes the selected text shown in a user interface and requested user interface functionality to be triggered that affects the selected text shown in the user interface. The computer-implemented method further includes prompting a large language model with the prompt. The computer-implemented method further includes receiving a result of the prompt, the result comprising a particular transformation specification applicable to the selected text. The computer-implemented method further includes providing the particular transformation specification to the application to transform, on the user interface, the selected text, and causing display of the transformation of the selected text.

In one example, a user may highlight a table of text, a visualization, or other content in a user interface. The user may type into a chat window or select, via a menu, “add to report package,” “summarize,” or “rephrase,” “read aloud,” or “update content.” The added content may be saved to a package that is loadable across different applications, such as Microsoft Excel®, Word®, PowerPoint®, etc. A selection to summarize selected text, visualization, or other content may trigger a call to an LLM to summarize the selected text or data, optionally with metadata being passed into the LLM about underlying descriptions of the cells or columns selected and the dimensions or members they represent, or other underlying schema information. A selection to rephrase selected text or other content may trigger a call to an LLM to generate different text that means the same thing as the selected text, optionally with metadata being passed into the LLM about underlying descriptions of the cells or columns selected and the dimensions or members they represent, or other underlying schema information. A selection to read aloud causes the selected content or content generated in the chat session to be read aloud. A selection to update content causes new content, for example, content generated from and/or selected from the chat session, to replace content that has been selected in another region of the user interface. For example, the user may request that a summary be generated and that the selected content be updated with the generated content.

In one embodiment, the summary or other transformation of selected text, visualization, or other content, if requested, may be returned in a chat window or adjacent to the selected content (e.g., in a different user interface sub-region as the selected content) as displayed in a main user interface region that may be separate from the chat window. The summary may be moved by referring to the generated summary in the chat window. For example, the summary may be moved to be adjacent to the selected content as displayed, above, below, or beside the selected content, at a beginning or end of a report or other document being modified, or otherwise in a different region of the interface as the selected content. The user interface may also provide options for moving the generated content to a slide deck, to a spreadsheet, or to another target document. In another embodiment, the generated summary or other transformation may replace the selected content by being displayed in a same region as where the selected content was previously displayed.

### Retrieving Saved UI Components in a Chat Session as Thumbnails with Actual Previewed Data Selectable for Inclusion in a Described UI Section

Content may also be selected by typing, into the chat window, “list available content,” in which case content from a current project or report package may be shown for optional inclusion in a report. The content may be shown in thumbnail form in the chat session as it would appear if moved to the document but in reduced size. The content may be selected directly from the chat window to add to the report being shown, or to a slide deck, spreadsheet or other target document. Upon addition to a document, the content appears in non-reduced size.

In one embodiment, a computer-implemented method includes accessing a natural language request received in a user session with an application. The computer-implemented method detects that the natural language request is for additional content to be added to a user interface. In response to the natural language request, the computer-implemented method causes generation of a plurality of selectable reduced scale images of visualizations based at least in part on the content. In response to selection of a particular selectable reduced scale image of the plurality of selectable reduced scale images, the computer-implemented method causes a particular non-reduced scale image corresponding to the reduced scale image to be added to the user interface and displayed.

In various embodiments, the thumbnail provides an improvement over existing technologies which allow items to be selected from a drop-down list and cannot show a scrollable set of visualizations with simulated actual data in a reduced size version of the visualization.

Thumbnail versions of visualizations or other data representations may be provided before prompting a large language model to display a non-reduced scale image according to a selected visualization or other data representation. Such selection may be made using the thumbnail. In another embodiment, the thumbnail versions are produced by prompting the large language model to display reduced scale images according to data selected on the interface, such that the content of the thumbnails match the content selected on the interface. In some embodiments, thumbnails selected to be shown for use with a selected or displayed dataset may be filtered based on which thumbnails are most relevant to the selected or displayed dataset. For example, metadata stored in association with the thumbnail may indicate which thumbnails are appropriate for which types of datasets. Such metadata may be provided to the LLM, and/or used in heuristics or a semantic search to select a most relevant set of thumbnails as options for visualizing or viewing a set of data.

### Generating a Summary of Multidimensional Data Featured in a Visualization Component in a User Interface Via a Natural Language Request Referring to the Visualization Component

In various embodiments, summaries may be generated based on displayed data and/or based on data that was generated by the LLM, and the summary may take advantage of an underlying understanding of a schema represented by the displayed or generated data. The summary may include additional information other than what is shown to summarize an item selected or referenced in a user interface, and the additional information may come from knowledge inherent in the LLM and/or information about the underlying schema passed into the LLM.

In one embodiment, a computer-implemented method comprises accessing a natural language request received in a user session with an application. A visualization is selected in the user session when the natural language request is received. The computer-implemented method generates a prompt that describes the selected visualization shown in a user interface and requested content to be generated based at least in part on the selected visualization shown in the user interface. The computer-implemented method includes prompting a large language model with the prompt, and receiving a result of the prompt. The result includes particular content based at least in part on the selected visualization. The computer-implemented method further comprises causing display of the particular content on the user interface such that the particular content is viewable at least in part concurrently with the selected visualization.

### AI Agent Architecture for Controlling Interface Functionality

Various elements of the present disclosure for controlling interface functionality may be performed by an artificial intelligence agent. One or more artificial intelligence agents may be tasked with controlling interface functionality and/or generating information in support of interface functionality for one or more projects. Each artificial intelligence agent may be trained or configured to perform specific tasks with regards to project information such as generating a prompt for execution by a large language model or performing tasks of generating or interpreting data.

The one or more artificial intelligence agents may be specific to a certain type of information or use case. For example, an artificial intelligence agent may be trained or configured only using information or processes relating to sales data or in support of sales reporting functionality or interface tools used in sales reporting, in which case the artificial intelligence agent may be specific to the handling of or generation of information relating to sales data such as sales forecast information, profit information, or realization information, or visualizations thereof. Another artificial intelligence agent may be trained or configured only using supply chain data or processes or in support of supply chain reporting functionality or interface tools used in supply chain reporting, in which case the artificial intelligence agent may be specific to handling of or generation of information relating to supply chain data such as supply chain forecast information, information about bottlenecks, or information about delays, or visualizations thereof.

In yet another example, an artificial intelligence agent may be assigned to only perform operations relating to a certain set of parameters of data within a set of data and may be utilized only in the case where parameter(s) of the certain set of parameters of data are present within the project information or have been determined to be relevant for generating the requested information.

An artificial intelligence agent may be specific to a certain role or task such as generating summaries, rephrasing text, generating visualizations, generating views, updating views, updating visualizations, generating certain types of visualizations or charts, certain shapes of multidimensional data (e.g., flat with one or two layers, shallow with two, three, or four layers, or deep with three, four, five, or more layers), generating reports or certain types of reports, generating data specific to another different application or content consumer (e.g., with different agents supporting outputs for consumption by different applications), or analyzing displayed data. An artificial intelligence agent may analyze data such as a natural language input from a user and/or one or more dimension names and/or values or other information determined to be relevant to the request, and may include any such data in a prompt to a large language model. An artificial intelligence agent may generate information by taking as input one or more values or sets of data and generating a prompt to a large language model to perform an action or generate a result for performing an action that is based on the input data as well as any relevant domains of knowledge otherwise available to the large language model.

One or more artificial intelligence agents may be selected for processing information by first determining a type of information or use case. The determined type of information or use case may then be compared to a type of information or use case associated with each artificial intelligence agent of a plurality of pre-trained and/or pre-configured artificial intelligence agents. The information may be determined to include a plurality of types of data, such as information relating to multiple different items of requested or relevant application functionality, in which case the different items of requested or relevant application functionality may be triggered by information generated using a plurality of artificial intelligence agents. The agents may be coordinated as worker agents by a supervising agent, and the supervising agent may merge results from the worker agents into a combined result, such as a combined data structure for triggering or a user interface including multiple components for display.

Different artificial intelligence agents may have different tools or accesses to input information based on their different use cases. For example, one artificial intelligence agent may have access to a set of private data that another artificial intelligence agent does not have access to in order to prevent the set of private data being publicly disclosed. As another example, any agent may have access to external data, such as an external news feed specific to a set of data, that is not accessible to the other agent(s).

In one embodiment, a managing agent determines one or more types of information being analyzed, and the managing agent assigns one or more worker agents specialized to handle each of the one or more types determined. The worker agents may analyze the information with the assistance of generative artificial intelligence, one or more customized prompt templates optionally specific to the corresponding worker agent, and/or one or more customized tools optionally specific to the to the corresponding worker agent. The managing agent may then assemble results from the one or more worker agents to provide a cohesive combined result for causing application functionality.

The one or more artificial intelligence agents may perform additional tasks prior to or after prompting a large language model for generating information relevant to the type of information or use case associated with the agent. For example, an artificial intelligence agent used for summarizing information involving personally identifiable information may perform an extra step prior to generating a prompt of removing or masking certain personally identifiable information from the data such that the personally identifiable information is not exposed to the large language model. In another example, the same artificial intelligence agent may, after generating a prompt and prompting a large language model to generate a summary, perform an extra step of analyzing the generated summary and editing the summary or re-prompting the large language model to generate a new summary when aspects of the summary indicate a bias. The additional tasks may be facilitated by a set of tools accessible by the one or more artificial intelligence agents such as access to submit API calls, other machine learning models, templates, or access to further artificial intelligence agents.

Access to the set of tools by artificial intelligence agents may be managed by using one or more authentication keys. The one or more authentication keys may determine which artificial intelligence agents access which tools by controlling access to the authentication keys for each artificial intelligence agent. A first artificial intelligence agent may, for example, have access to an API as a tool via access to one or more authentication keys that are inaccessible to a second artificial intelligence agent. The authentication keys may be simple, static credentials issued to identify applications accessing a tool such as an API. The authentication key may be included in an access request to a tool such as in a request header or URL parameter to an API. In one example, API keys may include credentials issued to identify applications (e.g., the data management system, etc.) accessing an API, and may be included in request headers, URL parameters, etc., without necessarily having a built-in expiration or user-based access control.

An authentication key may also be a temporary access token granted after authentication such that access to the tool is time-limited. An authentication key may also be a credential of a set of credentials such as a username and password, such as for accessing a tool via a user's login, where the user is the current user requesting a summary to be generated by the artificial intelligence agent. For example, bearer tokens (e.g., OAuth 2.0, etc.) may include temporary access tokens (e.g., granted after a more comprehensive authentication such as OAuth 2.0), allowing secure, time-limited access to resources (e.g., agent tools) without necessarily exposing credentials.

Other methods for accessing agent tools may include ‘Basic Authentication’, which is a process that involves sending a username and password encoded in a request (e.g., HTTP request, HTTPS request, etc.). Another example authentication mechanism includes JSON Web Tokens (JWT), which encode user information for token-based authentication. Another example authentication mechanism includes Mutual TLS (mTLS) which could add an extra layer of security by requiring client and server devices to authenticate each other using certificates. Another example authentication mechanism includes Hash-based Message authentication code (HMAC), where message integrity may be ensured by signing requests with a secret key. Other authentication mechanisms are possible as well depending on security requirements or preferences, user-specific access requirements or preferences, and/or sensitivity of data retrieved using the agent tools, among other factors.

In various embodiments, different agents may have access to different authentication mechanisms and/or different authentication keys, shared secrets, or other authentication parameters, which may provide different levels of access to the different agents. For example, a performer agent may have access to a first set of tool(s) that use a first set of data to support requests for the performer agent, and an evaluator agent may have access to a second set of tool(s) that use a second set of data to support requests for the evaluator agent. The same or different level(s) of access to same or different tool(s) may be driven by same or different authentication parameter(s) used by the different agents, and the authentication parameter(s) may be communicated to same or different API(s) that support tool functionality, which may have access to same or different set(s) of data in a back-end database, such as access that is driven by role(s) or security profile(s) associated with the authentication parameters provided to authenticate for API use and/or separate role(s) or security profile(s) managed by the tool that provides data lookup, analysis, management, data generation or other content generation, or other functionality to the agent(s).

The set of tools accessible by the one or more artificial intelligence agents may be specific to the artificial intelligence agent or the use case of the artificial intelligence agent, such as access to a personnel management toolkit for pre-processing or post-processing data outside of an LLM prompt or response. The tool(s) accessible by an artificial intelligence agent for a human resources use case might not be accessible by artificial intelligence agents of other use cases so as to not expose personally identifiable information to other artificial intelligence agents. The set of tools accessible by the one or more artificial intelligence agents may also be a generic tool used to facilitate any artificial intelligence agent in the performance of tasks specific to their use case, such as a data search tool used by an artificial intelligence agent to determine the specific parameters or sets of data relevant to its use case.

In one example, the one or more artificial intelligence agents includes a managing artificial intelligence agent, which instantiates each of the one or more artificial intelligence agents used in generating relevant information. The managing artificial intelligence agent may determine a number of other artificial intelligence agents to use for generating each item of relevant information, such as by processing or performing semantic search on dimensions of data to determine a relevant type of information or use case, or a type of information or use case with a vector embedding similar to an item of relevant information. The managing artificial intelligence agent may also determine an order of operations to perform by different agents and how results of the operations are to be combined together, and/or how agent(s) should coordinate with each other to produce results.

The one or more artificial intelligence agents may communicate between each other by sharing information, analyses, and/or generated content based on same or different inputs. For example, a first artificial intelligence agent may be tasked with performing data analysis and pre-processing on a set of data, such as by applying one or more operations on a set of data to prepare the data for further analysis, and the results of the first artificial intelligence agent may be provided to a second artificial intelligence agent for generating a information such as a data structure to trigger UI functionality, for example, by interacting with a large language model. Artificial intelligence agents may share information including project information detected by the artificial intelligence agent to be relevant project information for an agent-specific use case. For example, a number of artificial intelligence agents may generate information about separate sets of data, such as how such data should be displayed in an interface, and may send information about their separate sets of data to another artificial intelligence agent tasked with generating information about all of the sets of data, such as how to combine the different presentations of data into a combined data presentation, such as a view or visualization.

### Computer System Architecture

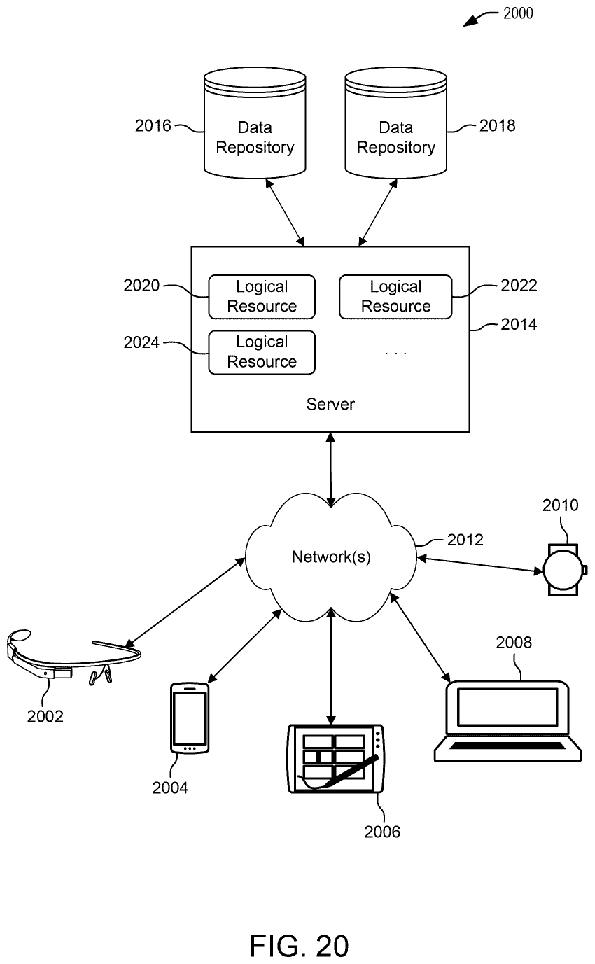

FIG. 20 depicts a simplified diagram of a distributed system 2000 for implementing an embodiment. In the illustrated embodiment, distributed system 2000 includes one or more client computing devices 2002, 2004, 2006, 2008, and/or 2010 coupled to a server 2014 via one or more communication networks 2012. Clients computing devices 2002, 2004, 2006, 2008, and/or 2010 may be configured to execute one or more applications.

In various aspects, server 2014 may be adapted to run one or more services or software applications that enable techniques for triggering functionality on data to be generated in a user interface and/or data shown or visualized in a user interface based on a natural language request that references actions to be performed and data items to use in performing the actions.

In certain aspects, server 2014 may also provide other services or software applications that can include non-virtual and virtual environments. In some aspects, these services may be offered as web-based or cloud services, such as under a Software as a Service (SaaS) model to the users of client computing devices 2002, 2004, 2006, 2008, and/or 2010. Users operating client computing devices 2002, 2004, 2006, 2008, and/or 2010 may in turn utilize one or more client applications to interact with server 2014 to utilize the services provided by these components.

In the configuration depicted in FIG. 20, server 2014 may include one or more components 2020, 2022 and 2024 that implement the functions performed by server 2014. These components may include software components that may be executed by one or more processors, hardware components, or combinations thereof. It should be appreciated that various different system configurations are possible, which may be different from distributed system 2000. The embodiment shown in FIG. 20 is thus one example of a distributed system for implementing an embodiment system and is not intended to be limiting.

Users may use client computing devices 2002, 2004, 2006, 2008, and/or 2010 for techniques for triggering functionality on data to be generated in a user interface and/or data shown or visualized in a user interface based on a natural language request that references actions to be performed and data items to use in performing the actions in accordance with the teachings of this disclosure. A client device may provide an interface that enables a user of the client device to interact with the client device. The client device may also output information to the user via this interface. Although FIG. 20 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 2012 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk™, and the like. Merely by way of example, network(s) 2012 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth, and/or any other wireless protocol), and/or any combination of these and/or other networks.

Server 2014 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 2014 can include one or more virtual machines running virtual operating systems, or other computing architectures involving virtualization such as one or more flexible pools of logical storage devices that can be virtualized to maintain virtual storage devices for the server. In various aspects, server 2014 may be adapted to run one or more services or software applications that provide the functionality described in the foregoing disclosure.

The computing systems in server 2014 may run one or more operating systems including any of those discussed above, as well as any commercially available server operating system. Server 2014 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 2014 may include one or more applications to analyze and consolidate data feeds and/or event updates received from users of client computing devices 2002, 2004, 2006, 2008, and/or 2010. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 2014 may also include one or more applications to display the data feeds and/or real-time events via one or more display devices of client computing devices 2002, 2004, 2006, 2008, and/or 2010.

Distributed system 2000 may also include one or more data repositories 2016, 2018. These data repositories may be used to store data and other information in certain aspects. For example, one or more of the data repositories 2016, 2018 may be used to store information for techniques for triggering functionality on data to be generated in a user interface and/or data shown or visualized in a user interface based on a natural language request that references actions to be performed and data items to use in performing the actions. Data repositories 2016, 2018 may reside in a variety of locations. For example, a data repository used by server 2014 may be local to server 2014 or may be remote from server 2014 and in communication with server 2014 via a network-based or dedicated connection. Data repositories 2016, 2018 may be of different types. In certain aspects, a data repository used by server 2014 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 2016, 2018 may also be used by applications to store application data. The data repositories used by applications may be of different types such as, for example, a key-value store repository, an object store repository, or a general storage repository supported by a file system.

In one embodiment, server 2014 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

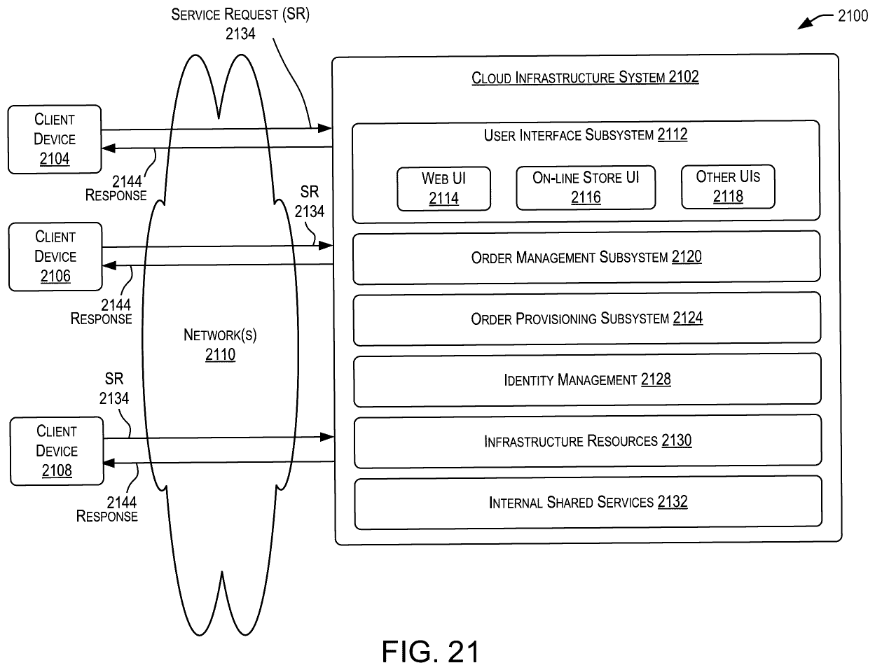

FIG. 21 is a simplified block diagram of a cloud-based system environment in which triggers functionality on data to be generated in a user interface and/or data shown or visualized in a user interface based on a natural language request that references actions to be performed and data items to use in performing the actions, in accordance with certain aspects. In the embodiment depicted in FIG. 21, cloud infrastructure system 2102 may provide one or more cloud services that may be requested by users using one or more client computing devices 2104, 2106, and 2108. Cloud infrastructure system 2102 may comprise one or more computers and/or servers that may include those described above for server 2014. The computers in cloud infrastructure system 2102 may be organized as general purpose computers, specialized server computers, server farms, server clusters, or any other appropriate arrangement and/or combination.

Network(s) 2110 may facilitate communication and exchange of data between clients 2104, 2106, and 2108 and cloud infrastructure system 2102. Network(s) 2110 may include one or more networks. The networks may be of the same or different types. Network(s) 2110 may support one or more communication protocols, including wired and/or wireless protocols, for facilitating the communications.

The embodiment depicted in FIG. 21 is only one example of a cloud infrastructure system and is not intended to be limiting. It should be appreciated that, in some other aspects, cloud infrastructure system 2102 may have more or fewer components than those depicted in FIG. 21, may combine two or more components, or may have a different configuration or arrangement of components. For example, although FIG. 21 depicts three client computing devices, any number of client computing devices may be supported in alternative aspects.

The term cloud service is generally used to refer to a service that is made available to users on demand and via a communication network such as the Internet by systems (e.g., cloud infrastructure system 2102) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 2110 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 2102 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 2102 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 2102. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 2102. Cloud infrastructure system 2102 then performs processing to provide the services requested in the tenant's subscription order. Cloud infrastructure system 2102 may be configured to provide one or even multiple cloud services.

Cloud infrastructure system 2102 may provide the cloud services via different deployment models. In a public cloud model, cloud infrastructure system 2102 may be owned by a third party cloud services provider and the cloud services are offered to any general public tenant, where the tenant can be an individual or an enterprise. In certain other aspects, under a private cloud model, cloud infrastructure system 2102 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 2102 and the services provided may be shared by several organizations in a related community. Various other models such as hybrids of the above mentioned models may also be used.

Client computing devices 2104, 2106, and 2108 may be of different types (such as devices 2002, 2004, 2006, and 2008 depicted in FIG. 20) and may be capable of operating one or more client applications. A user may use a client device to interact with cloud infrastructure system 2102, such as to request a service provided by cloud infrastructure system 2102.

In some aspects, the processing performed by cloud infrastructure system 2102 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 2102 for determining the intent of an utterance. The data used for this analysis may include structured data (e.g., data stored in a database or structured according to a structured model) and/or unstructured data (e.g., data blobs (binary large objects)).

As depicted in the embodiment in FIG. 21, cloud infrastructure system 2102 may include infrastructure resources 2130 that are utilized for facilitating the provision of various cloud services offered by cloud infrastructure system 2102. Infrastructure resources 2130 may include, for example, processing resources, storage or memory resources, networking resources, and the like.

In certain aspects, to facilitate efficient provisioning of these resources for supporting the various cloud services provided by cloud infrastructure system 2102 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 2102 may itself internally use services 2132 that are shared by different components of cloud infrastructure system 2102 and which facilitate the provisioning of services by cloud infrastructure system 2102. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 2102 may comprise multiple subsystems. These subsystems may be implemented in software, or hardware, or combinations thereof. As depicted in FIG. 21, the subsystems may include a user interface subsystem 2112 that enables users of cloud infrastructure system 2102 to interact with cloud infrastructure system 2102. User interface subsystem 2112 may include various different interfaces such as a web interface 2114, an online store interface 2116 where cloud services provided by cloud infrastructure system 2102 are advertised and are purchasable by a consumer, and other interfaces 2118. For example, a tenant may, using a client device, request (service request 2134) one or more services provided by cloud infrastructure system 2102 using one or more of interfaces 2114, 2116, and 2118. For example, a tenant may access the online store, browse cloud services offered by cloud infrastructure system 2102, and place a subscription order for one or more services offered by cloud infrastructure system 2102 that the tenant wishes to subscribe to. The service request may include information identifying the tenant and one or more services that the tenant desires to subscribe to. For example, a tenant may place a subscription order for a chatbot related service offered by cloud infrastructure system 2102. As part of the order, the client may provide information identifying the input (e.g. utterances).

In certain aspects, such as the embodiment depicted in FIG. 21, cloud infrastructure system 2102 may comprise an order management subsystem (OMS) 2120 that is configured to process the new order. As part of this processing, OMS 2120 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 2120 may then invoke the order provisioning subsystem (OPS) 2124 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 2124 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 2102 may send a response or notification 2144 to the requesting tenant to indicate when the requested service is now ready for use. In some instances, information (e.g., a link) may be sent to the tenant that enables the tenant to start using and availing the benefits of the requested services.

Cloud infrastructure system 2102 may provide services to multiple tenants. For each tenant, cloud infrastructure system 2102 is responsible for managing information related to one or more subscription orders received from the tenant, maintaining tenant data related to the orders, and providing the requested services to the tenant or clients of the tenant. Cloud infrastructure system 2102 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 2102 may provide services to multiple tenants in parallel. Cloud infrastructure system 2102 may store information for these tenants, including possibly proprietary information. In certain aspects, cloud infrastructure system 2102 comprises an identity management subsystem (IMS) 2128 that is configured to manage tenant's information and provide the separation of the managed information such that information related to one tenant is not accessible by another tenant. IMS 2128 may be configured to provide various security-related services such as identity services, such as information access management, authentication and authorization services, services for managing tenant identities and roles and related capabilities, and the like.

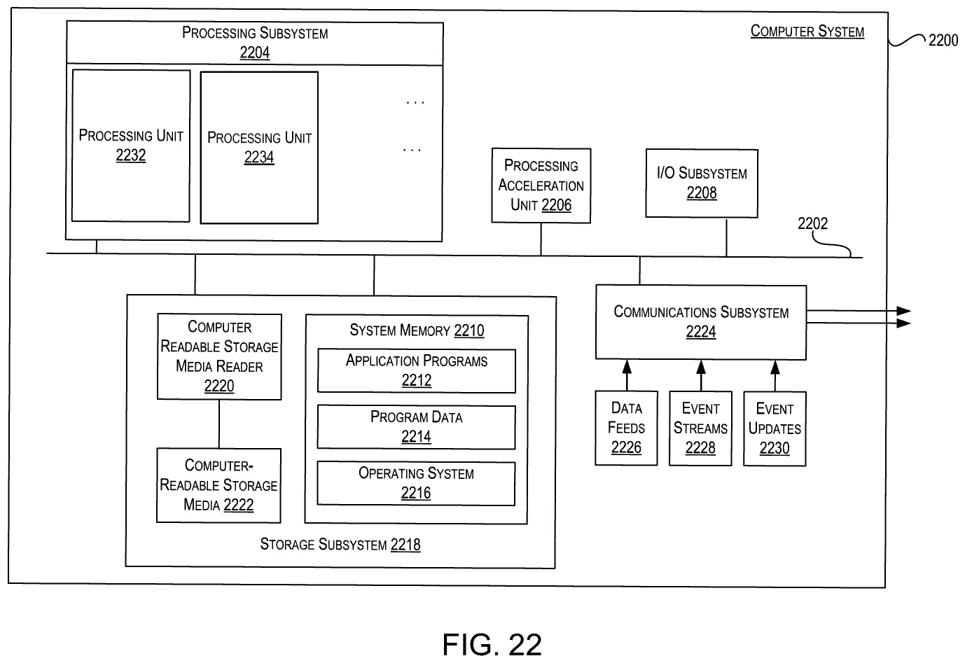

FIG. 22 illustrates an exemplary computer system 2200 that may be used to implement certain aspects. As shown in FIG. 22, computer system 2200 includes various subsystems including a processing subsystem 2204 that communicates with a number of other subsystems via a bus subsystem 2202. These other subsystems may include a processing acceleration unit 2206, an I/O subsystem 2208, a storage subsystem 2218, and a communications subsystem 2224. Storage subsystem 2218 may include non-transitory computer-readable storage media including storage media 2222 and a system memory 2210.

Bus subsystem 2202 provides a mechanism for letting the various components and subsystems of computer system 2200 communicate with each other as intended. Although bus subsystem 2202 is shown schematically as a single bus, alternative aspects of the bus subsystem may utilize multiple buses. Bus subsystem 2202 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 2204 controls the operation of computer system 2200 and may comprise one or more processors, application specific integrated circuits (ASICs), or field programmable gate arrays (FPGAs). The processors may be single core or multicore processors. The processing resources of computer system 2200 can be organized into one or more processing units 2232, 2234, etc. A processing unit may include one or more processors, one or more cores from the same or different processors, a combination of cores and processors, or other combinations of cores and processors. In some aspects, processing subsystem 2204 can include one or more special purpose co-processors such as graphics processors, digital signal processors (DSPs), or the like. In some aspects, some or all of the processing units of processing subsystem 2204 can be implemented using customized circuits, such as application specific integrated circuits (ASICs), or field programmable gate arrays (FPGAs).

In some aspects, the processing units in processing subsystem 2204 can execute instructions stored in system memory 2210 or on computer readable storage media 2222. In various aspects, the processing units can execute a variety of programs or code instructions and can maintain multiple concurrently executing programs or processes. At any given time, some or all of the program code to be executed can be resident in system memory 2210 and/or on computer-readable storage media 2222 including potentially on one or more storage devices. Through suitable programming, processing subsystem 2204 can provide various functionalities described above. In instances where computer system 2200 is executing one or more virtual machines, one or more processing units may be allocated to each virtual machine.

In certain aspects, a processing acceleration unit 2206 may optionally be provided for performing customized processing or for off-loading some of the processing performed by processing subsystem 2204 so as to accelerate the overall processing performed by computer system 2200.

I/O subsystem 2208 may include devices and mechanisms for inputting information to computer system 2200 and/or for outputting information from or via computer system 2200. In general, use of the term input device is intended to include all possible types of devices and mechanisms for inputting information to computer system 2200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 2200 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 2218 provides a repository or data store for storing information and data that is used by computer system 2200. Storage subsystem 2218 provides a tangible non-transitory computer-readable storage medium for storing the basic programming and data constructs that provide the functionality of some aspects. Storage subsystem 2218 may store software (e.g., programs, code modules, instructions) that when executed by processing subsystem 2204 provides the functionality described above. The software may be executed by one or more processing units of processing subsystem 2204. Storage subsystem 2218 may also provide a repository for storing data used in accordance with the teachings of this disclosure.

Storage subsystem 2218 may include one or more non-transitory memory devices, including volatile and non-volatile memory devices. As shown in FIG. 22, storage subsystem 2218 includes a system memory 2210 and a computer-readable storage media 2222. System memory 2210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 2200, such as during start-up, may typically be stored in the ROM. The RAM typically contains data and/or program modules that are presently being operated and executed by processing subsystem 2204. In some implementations, system memory 2210 may include multiple different types of memory, such as static random access memory (SRAM), dynamic random access memory (DRAM), and the like.

By way of example, and not limitation, as depicted in FIG. 22, system memory 2210 may load application programs 2212 that are being executed, which may include various applications such as Web browsers, mid-tier applications, relational database management systems (RDBMS), etc., program data 2214, and an operating system 2216. By way of example, operating system 2216 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 2222 may store programming and data constructs that provide the functionality of some aspects. Computer-readable media 2222 may provide storage of computer-readable instructions, data structures, program modules, and other data for computer system 2200. Software (programs, code modules, instructions) that, when executed by processing subsystem 2204 provides the functionality described above, may be stored in storage subsystem 2218. By way of example, computer-readable storage media 2222 may include non-volatile memory such as a hard disk drive, a magnetic disk drive, an optical disk drive such as a CD ROM, digital video disc (DVD), a Blu-Ray® disk, or other optical media. Computer-readable storage media 2222 may include, but is not limited to, Zip® drives, flash memory cards, universal serial bus (USB) flash drives, secure digital (SD) cards, DVD disks, digital video tape, and the like. Computer-readable storage media 2222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 2218 may also include a computer-readable storage media reader 2220 that can further be connected to computer-readable storage media 2222. Reader 2220 may receive and be configured to read data from a memory device such as a disk, a flash drive, etc.

In certain aspects, computer system 2200 may support virtualization technologies, including but not limited to virtualization of processing and memory resources. For example, computer system 2200 may provide support for executing one or more virtual machines. In certain aspects, computer system 2200 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 2200. Accordingly, multiple operating systems may potentially be run concurrently by computer system 2200.

Communications subsystem 2224 provides an interface to other computer systems and networks. Communications subsystem 2224 serves as an interface for receiving data from and transmitting data to other systems from computer system 2200. For example, communications subsystem 2224 may enable computer system 2200 to establish a communication channel to one or more client devices via the Internet for receiving and sending information from and to the client devices. For example, the communications subsystem may be used to transmit a response to a user regarding the inquiry for a chatbot.

Communications subsystem 2224 may support both wired and/or wireless communication protocols. For example, in certain aspects, communications subsystem 2224 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 2224 can provide wired network connectivity (e.g., Ethernet) in addition to or instead of a wireless interface.

Communications subsystem 2224 can receive and transmit data in various forms. For example, in some aspects, in addition to other forms, communications subsystem 2224 may receive input communications in the form of structured and/or unstructured data feeds 2226, event streams 2228, event updates 2230, and the like. For example, communications subsystem 2224 may be configured to receive (or send) data feeds 2226 in real-time from users of social media networks and/or other communication services such as Twitter feeds, Facebook® updates, web feeds such as Rich Site Summary (RSS) feeds, and/or real-time updates from one or more third party information sources.

In certain aspects, communications subsystem 2224 may be configured to receive data in the form of continuous data streams, which may include event streams 2228 of real-time events and/or event updates 2230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2224 may also be configured to communicate data from computer system 2200 to other computer systems or networks. The data may be communicated in various different forms such as structured and/or unstructured data feeds 2226, event streams 2228, event updates 2230, and the like to one or more databases that may be in communication with one or more streaming data source computers coupled to computer system 2200.

Computer system 2200 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 2200 depicted in FIG. 22 is intended only as a specific example. Many other configurations having more or fewer components than the system depicted in FIG. 22 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a natural language request received in a user session with an application; wherein content is graphically selected in the user session when the natural language request is received;
generating a prompt that includes the natural language request, information indicating the selected content, and one or more interface functionality controls for controlling interface functionality to generate output content;
prompting a large language model with the prompt;
receiving a result of the prompt, the result comprising an interface functionality specification that uses at least one of the one or more interface functionality controls and is based at least in part on the information indicating the selected content;
causing execution of the at least one of the one or more interface functionality controls to generate particular output content that is based at least in part on the information indicating the selected content;
storing the particular output content in association with a content consumer for display in a user interface.

2. The computer-implemented method of claim 1, wherein the particular output content comprises a textual transformation of the graphically selected content, wherein the at least one of the one or more interface functionality controls causes display of the textual transformation on the user interface; wherein the graphically selected content comprises textual content displayed in a first region of the user interface; wherein the information indicating the selected content comprises at least part of the selected content; and wherein the at least one of the one or more interface functionality controls causes display of the textual transformation in a second region of the user interface concurrently with the textual content.

3. The computer-implemented method of claim 1, wherein the particular output content comprises a textual transformation of the graphically selected content, wherein the at least one of the one or more interface functionality controls causes display of the textual transformation on the user interface; wherein the graphically selected content comprises a visualization displayed on the user interface, wherein the information indicating the selected content comprises a data schema corresponding to one or more data slices shown in the visualization; and wherein the at least one of the one or more interface functionality controls causes display of the textual transformation concurrently with the visualization.

4. The computer-implemented method of claim 1, wherein the particular output content comprises a textual transformation of the graphically selected content, wherein the at least one of the one or more interface functionality controls causes display of the textual transformation on the user interface; wherein the graphically selected content is displayed on the user interface before storing the particular output content in association with a content consumer separately from the graphically selected content, and wherein the at least one of the one or more interface functionality controls causes display of the textual transformation instead of the graphically selected content on the user interface after storing the particular output content in association with the content consumer.

5. The computer-implemented method of claim 1, further comprising:
causing display of a plurality of reduced-scale images corresponding to different candidate visualization types that are stored in association with different interface functionality controls;
receiving a selection of a particular selectable reduced-scale image of the plurality of reduced-scale images, the selection indicating a candidate visualization type; and
based at least in part on the selection, selecting for inclusion in the prompt, the one or more interface functionality controls stored in association with the candidate visualization type.

6. The computer-implemented method of claim 5, wherein the plurality of reduced-scale images corresponding to the different candidate visualization types are determined after filtering a superset of candidate visualization types to exclude one or more other candidate visualization types and include the different candidate visualization types based on relevance to the graphically selected content.

7. The computer-implemented method of claim 5, wherein the plurality of reduced-scale images corresponding to the different candidate visualization types are displayed in a chat region of the user interface where the natural language request is received.

8. The computer-implemented method of claim 1, wherein the generating the prompt, the prompting the large language model, the receiving the result, the causing execution of the at least one of the one or more interface functionality controls, and the storing the particular output content are performed as separate process instances for each of a plurality of different interface functionality controls that control a plurality of different candidate visualization types; and wherein completion of the separate process instances of the storing the particular output content causes the particular output content for each of the separate process instances to be displayed as a selectable reduced-scale image of a plurality of selectable reduced-scale images; wherein the computer-implemented method further comprises:
receiving a selection of a particular selectable reduced-scale image of the plurality of reduced-scale images; and
based at least in part on the selection, causing a particular non-reduced scale image corresponding to the reduced scale image to be added to the user interface and displayed.

9. The computer-implemented method of claim 1, wherein the content is graphically selected in the user session using a first user interface of the application; wherein the content consumer is a different application; the computer-implemented method further comprising instantiating the different application with the particular output content to cause the display in the user interface; and wherein the user interface is a second user interface of the different application.

10. The computer-implemented method of claim 1, wherein the particular output content comprises a textual transformation of the graphically selected content; the computer-implemented method further comprising:
causing display of the particular output content in a chat region of the user interface where the natural language request is received;
receiving a selection, from the chat region, to include the particular output content in another region of the user interface as part of a target object;
wherein the at least one of the one or more interface functionality controls causes, in response to the selection, display of the textual transformation in the other region of the user interface as part of the target object.

11. A computer-program product comprising one or more non-transitory machine-readable storage media, including stored instructions configured to cause a computing system to perform a set of actions including:
accessing a natural language request received in a user session with an application; wherein content is graphically selected in the user session when the natural language request is received;
generating a prompt that includes the natural language request, information indicating the selected content, and one or more interface functionality controls for controlling interface functionality to generate output content;
prompting a large language model with the prompt;
receiving a result of the prompt, the result comprising an interface functionality specification that uses at least one of the one or more interface functionality controls and is based at least in part on the information indicating the selected content;
causing execution of the at least one of the one or more interface functionality controls to generate particular output content that is based at least in part on the information indicating the selected content;
storing the particular output content in association with a content consumer for display in a user interface.

12. The computer-program product of claim 11, wherein the particular output content comprises a textual transformation of the graphically selected content, wherein the at least one of the one or more interface functionality controls causes display of the textual transformation on the user interface; wherein the graphically selected content comprises textual content displayed in a first region of the user interface; wherein the information indicating the selected content comprises at least part of the selected content; and wherein the at least one of the one or more interface functionality controls causes display of the textual transformation in a second region of the user interface concurrently with the textual content.

13. The computer-program product of claim 11, wherein the particular output content comprises a textual transformation of the graphically selected content, wherein the at least one of the one or more interface functionality controls causes display of the textual transformation on the user interface; wherein the graphically selected content comprises a visualization displayed on the user interface, wherein the information indicating the selected content comprises a data schema corresponding to one or more data slices shown in the visualization; and wherein the at least one of the one or more interface functionality controls causes display of the textual transformation concurrently with the visualization.

14. The computer-program product of claim 11, wherein the particular output content comprises a textual transformation of the graphically selected content, wherein the at least one of the one or more interface functionality controls causes display of the textual transformation on the user interface; wherein the graphically selected content is displayed on the user interface before storing the particular output content in association with a content consumer separately from the graphically selected content, and wherein the at least one of the one or more interface functionality controls causes display of the textual transformation instead of the graphically selected content on the user interface after storing the particular output content in association with the content consumer.

15. The computer-program product of claim 11, wherein the set of actions further include:
causing display of a plurality of reduced-scale images corresponding to different candidate visualization types that are stored in association with different interface functionality controls;
receiving a selection of a particular selectable reduced-scale image of the plurality of reduced-scale images, the selection indicating a candidate visualization type; and
based at least in part on the selection, selecting for inclusion in the prompt, the one or more interface functionality controls stored in association with the candidate visualization type.

16. The computer-program product of claim 11, wherein the content is graphically selected in the user session using a first user interface of the application; wherein the content consumer is a different application; wherein the set of actions further include instantiating the different application with the particular output content to cause the display in the user interface; and wherein the user interface is a second user interface of the different application.

17. The computer-program product of claim 11, wherein the particular output content comprises a textual transformation of the graphically selected content; wherein the set of actions further include:
causing display of the particular output content in a chat region of the user interface where the natural language request is received;
receiving a selection, from the chat region, to include the particular output content in another region of the user interface as part of a target object;
wherein the at least one of the one or more interface functionality controls causes, in response to the selection, display of the textual transformation in the other region of the user interface as part of the target object.

18. A system comprising:
one or more processors;
one or more non-transitory computer-readable media storing instructions, which, when executed by the system, cause the system to perform a set of actions including: accessing a natural language request received in a user session with an application; wherein content is graphically selected in the user session when the natural language request is received;
generating a prompt that includes the natural language request, information indicating the selected content, and one or more interface functionality controls for controlling interface functionality to generate output content;
prompting a large language model with the prompt;
receiving a result of the prompt, the result comprising an interface functionality specification that uses at least one of the one or more interface functionality controls and is based at least in part on the information indicating the selected content;
causing execution of the at least one of the one or more interface functionality controls to generate particular output content that is based at least in part on the information indicating the selected content;
storing the particular output content in association with a content consumer for display in a user interface.

19. The system of claim 18, wherein the particular output content comprises a textual transformation of the graphically selected content, wherein the at least one of the one or more interface functionality controls causes display of the textual transformation on the user interface; wherein the graphically selected content comprises textual content displayed in a first region of the user interface; wherein the information indicating the selected content comprises at least part of the selected content; and wherein the at least one of the one or more interface functionality controls causes display of the textual transformation in a second region of the user interface concurrently with the textual content.

20. The system of claim 18, wherein the particular output content comprises a textual transformation of the graphically selected content, wherein the at least one of the one or more interface functionality controls causes display of the textual transformation on the user interface; wherein the graphically selected content comprises a visualization displayed on the user interface, wherein the information indicating the selected content comprises a data schema corresponding to one or more data slices shown in the visualization; and wherein the at least one of the one or more interface functionality controls causes display of the textual transformation concurrently with the visualization.

21. The system of claim 18, wherein the particular output content comprises a textual transformation of the graphically selected content, wherein the at least one of the one or more interface functionality controls causes display of the textual transformation on the user interface; wherein the graphically selected content is displayed on the user interface before storing the particular output content in association with a content consumer separately from the graphically selected content, and wherein the at least one of the one or more interface functionality controls causes display of the textual transformation instead of the graphically selected content on the user interface after storing the particular output content in association with the content consumer.

22. The system of claim 18, wherein the set of actions further include:
causing display of a plurality of reduced-scale images corresponding to different candidate visualization types that are stored in association with different interface functionality controls;
receiving a selection of a particular selectable reduced-scale image of the plurality of reduced-scale images, the selection indicating a candidate visualization type; and
based at least in part on the selection, selecting for inclusion in the prompt, the one or more interface functionality controls stored in association with the candidate visualization type.

23. The system of claim 18, wherein the content is graphically selected in the user session using a first user interface of the application; wherein the content consumer is a different application; wherein the set of actions further include instantiating the different application with the particular output content to cause the display in the user interface; and wherein the user interface is a second user interface of the different application.

24. The system of claim 18, wherein the particular output content comprises a textual transformation of the graphically selected content; wherein the set of actions further include:
causing display of the particular output content in a chat region of the user interface where the natural language request is received;
receiving a selection, from the chat region, to include the particular output content in another region of the user interface as part of a target object;
wherein the at least one of the one or more interface functionality controls causes, in response to the selection, display of the textual transformation in the other region of the user interface as part of the target object.
